(19) United States
(12) Patent Application Publication
(10) Pub. No.: US 2026/0185556 A1
(43) Pub. Date: Jul. 2, 2026

(54) ROTARY JOINT ARRANGEMENT AND POSITIONING DEVICE COMPRISING THE ROTARY JOINT ARRANGEMENT AND A LINEAR GUIDE DEVICE

(71) Applicant: Schneeberger Holding AG, Roggwil (CH)

(72) Inventors: Andreas HOERMANNSDORFER, Village Neuf (FR); Roger FANKHAUSER, Langenthal (CH); Jean-Claude ZIHLMANN, Schötz (CH)

(73) Assignee: Schneeberger Holding AG, Roggwil (CH)

(21) Appl. No.: 19/128,278

(22) PCT Filed: Nov. 22, 2023
(86) PCT No.: PCT/EP2023/082684

§ 371 Date: May 8, 2025

Related U.S. Application Data
(60) Provisional application No. 63/427,260, filed on Nov. 22, 2022.

(51) Int. Cl. F16C 11/12

(52) U.S. Cl. CPC F16C 11/12; F16C 2380/18

(57) ABSTRACT

A rotary joint arrangement includes first and second parts, and a coupling device including at least one solid body joint for connecting the parts so that the second part is rotatable relative to the first part about an axis of rotation extending in a first direction, the first and second parts each having an extension perpendicular to the axis of rotation. The second part is offset from the first part by a distance axially to the axis of rotation. The coupling device includes first and second solid body joints, the first and second solid body joints each having two end sections and a central section connected to the end sections via elastically deformable web parts, and the respective end sections of the solid body joints being rigidly connected to the second part and the respective central section of the solid body joints being rigidly connected to the first part.

### CROSS REFERENCE TO RELATED APPLICATIONS

This application is the National Stage of PCT/EP2023/082684 filed on Nov. 22, 2023, which claims priority under 35 U.S.C. § 119 (e) of U.S. Provisional Patent Application Ser. No. 63/427,260 filed on Nov. 22, 2022, the disclosure of which is incorporated by reference. The international application under PCT article 21(2 ) was not published in English.

### TECHNICAL FIELD

The invention relates to a rotary joint arrangement comprising a first part, a second part and a coupling means comprising at least one solid body joint for connecting the first part and the second part, and a positioning device comprising the rotary joint arrangement with a linear guide device.

### Prior Art

Rotary joint arrangements of the above-mentioned type are generally designed in such a way that the coupling means is formed to connect the first part and the second part via the at least one solid body joint in such a way that the second part can be rotated relative to the first part about an axis of rotation extending in one direction, wherein the first part and the second part each have an extension perpendicular to the axis of rotation. A rotation of the first part relative to the second part about the axis of rotation is thereby associated with an elastic deformation of the solid body joint, which connects the first part and the second part.

A plurality of different solid body joints of the above-mentioned type are known, which each consist of a fixed end and a flexible end, wherein the fixed end and the flexible end are connected by means of a thin, resilient web, and the fixed end of the solid body joint is intended, for example, to be connected to the first part of a rotary joint arrangement of the above-mentioned type, while the flexible end of the solid body joint is intended to be connected to the second part of the rotary joint arrangement.

Rotary joint arrangements of the above-mentioned type are used, for example, in positioning devices for positioning a movable element, which positioning devices are suitable to move a movable element with respect to a flat surface formed on a base along two different directions, which are arranged at a right angle to one another. Positioning devices of this type often have two different axes, which are arranged at a right angle to one another and which extend parallel to the flat surface of the base, wherein the one axis is additionally guided on the other axis by means of guide means in such a way that the one axis can be moved relative to the other axis in the longitudinal direction of the other axis. A solid body joint of a rotary joint arrangement of the above-mentioned type is used thereby, for example, in order to connect the guide means to the one axis in such a way that the guide means can be rotated relative to the one axis about an axis of rotation, which extends, for example, essentially perpendicular to the flat surface of the base. In this case, the guide means are coupled to the one axis by means of the solid body joint in such a way that the guide means can be pivoted about the axis of rotation at least within a certain angular range with respect to the one axis and the spatial position of the guide means relative to the one axis can thus be changed. The guide means can thus always be held in a specified spatial position with respect to the other axis, even if the spatial position of the one axis relative to the other axis should be changed within certain tolerances. The respective tolerances with respect to the spatial position of the one axis relative to the other axis can thereby be compensated by means of a deformation of the solid body joint.

Positioning devices of this type are used, for example, in the semiconductor industry, in order to bring, for example, semiconductor wafers into different positions during process steps for producing microstructures on a surface of a semiconductor wafer or in order to position semiconductor wafers relative to measuring devices for metrological purposes.

For example with regard to industrial applications for performing process steps for producing microstructures or for inspecting and/or characterizing microstructures by means of measuring, there is a need for positioning devices, which are suitable to move a movable element (for example a platform or a table, respectively, for receiving an object to be positioned) in a first direction and in a second direction (i.e. two-dimensionally relative to a specified plane) at a largest possible speed and optionally with a largest possible acceleration (e.g. in the range of 2 g or more) and to thereby position it repeatedly and reproducibly in specified positions in each case with a large precision (i.e. with an accuracy in the sub-micrometer range).

In order to provide for a quick and precise positioning of a movable element in a first direction and in a second direction, positioning devices of the above-mentioned type often comprise a base (e.g. block made of granite) comprising a flat guide surface, which is arranged parallel to a first direction and parallel to a second direction, and a movement device for moving the movable element with respect to the flat guide surface of the base. A movement device of the above-mentioned type can thereby have, for example, a first movement means in Gantry design, among others, which comprises a Gantry beam, which is arranged above the flat guide surface and which extends in the second direction at a distance from the flat guide surface, and a Gantry drive for moving the Gantry beam relative to the base in the first direction. The Gantry beam thereby has a first end and a second end located opposite the first end, wherein the Gantry drive comprises two first linear axes extending in the first direction, each comprising a linear drive, and the two first linear axes extending in the first direction are designed in such a way that the linear drive of one of the two first linear axes is connected to the first end of the Gantry beam, and the linear drive of the other one of the two first linear axes is connected to the second end of the Gantry beam.

In order to make it possible to move the movable element in the first direction and in the second direction, the movable element is thereby mounted on the Gantry beam in such a way that the movable element can be moved linearly in the second direction on the Gantry bean, wherein the Gantry beam has a second linear axis extending in the second direction comprising a linear drive connected to the movable element for moving the movable element in the second direction.

In order to make it possible that the movable element can be repeatedly and reproducibly positioned in specified positions, each with a large precision (i.e. with an accuracy in the range of nanometers) relative to the guide surface of the base, it can be advantageous for many applications to support the Gantry beam of the first movement means during a movement along the flat guide surface of the base on the base by means of air bearings, so that, during a movement of the Gantry beam relative to the base, surface regions of the Gantry beam and of the guide surface of the base in the region of the air bearings located opposite one another and moved relative to one another are each separated by means of air cushions and can thus be moved relative to one another without contact.

With respect to many applications of positioning devices of the above-mentioned type, there is a need to form positioning devices of this type in a “highly dynamic manner”, so that they are suitable to move a movable element with a large acceleration (e.g. in the range of 2 g or more). In the case of a highly dynamic positioning device of the above-mentioned type, an essential requirement is that the positioning device and in particular the Gantry beam of the first movement means is deformed as little as possible as a result of the inertia during a large acceleration of the Gantry beam by means of the linear drives of the two first linear axes in the first direction as well as in response to a large acceleration of the movable element by means of the linear drive of the second linear axis in the second direction, and should thus have a largest possible stiffness with respect to a deformation in the form of a bending and/or a torsion about the first direction and/or the second direction.

With respect to positioning devices of the above-mentioned type, in the case of which the Gantry beam is guided on the base by means of air bearings and which are formed in a highly dynamic manner, structures have in particular become known, which have a “flat” configuration in such a way that the two linear drives of the first linear axes are arranged, if possible, at the height of the center of mass of all parts of the positioning device, which are moved by means of these two linear drives, in order to maximize the dynamic torsional stiffness (corresponding to a natural frequency) of the Gantry beam. The latter is associated with the fact that, the larger the vertical distance (i.e. perpendicular to the flat guide surface of the base) between the force vector of the linear drives of the two first linear axes acting on the Gantry beam and the center of mass of all parts of the positioning device, which are moved by means of the linear drives of the two first linear axes, the stronger the Gantry beam will twist in response to an accelerated movement in the first direction due to the inertia of the parts of the positioning device, which are moved by means of the linear drives of the two first linear axes, which, in a negative manner, lengthens the setting time, which the Gantry beam requires in order to reach a stable position again after an acceleration of the Gantry beam in the first direction.

A positioning device of the above-mentioned type, which is formed in a highly dynamic manner, in the case of which the Gantry beam is guided on a flat guide surface of a base by means of air bearings, is known, for example, from the publication CN 113977294 A. This positioning device is designed for a precise positioning of a movable element in the form of a movable table for receiving a workpiece (for example for a micro-processing of the workpiece). The Gantry beam of this positioning device is guided on a flat guide surface on the top side of the base by means of two horizontal air bearings, wherein one of the two horizontal air bearings is arranged on the first end of the Gantry beam, in order to support or to guide, respectively, the first end of the Gantry beam on the flat guide surface of the base during a movement in the first direction, and wherein the other one of the two horizontal air bearings is arranged on the second end of the Gantry beam, in order to support or to guide, respectively, the second end of the Gantry beam on the flat guide surface on the top side of the base during a movement in the first direction. The movable table to be positioned is movable in the second direction (longitudinal direction of the Gantry beam) by means of the linear drive of the second linear axis arranged on the Gantry beam and is likewise supported or guided, respectively, on the flat guide surface on the top side of the base by means of horizontal air bearings. In order to laterally guide the Gantry beam during a movement in the first direction, a lateral guide surface is provided, which extends parallel to the first direction and perpendicular to the flat guide surface of the base. With respect to the flat guide surface on the top side Of the base, the lateral guide surface is arranged approximately at the same height as the Gantry beam in such a way that the lateral guide surface is placed laterally next to the Gantry beam in the vicinity of one of the ends of the Gantry beam at a distance from this one end of the Gantry beam. The Gantry beam is guided on the one lateral guide surface by means of a lateral air bearing, which, for this purpose, is fastened on a side surface of the Gantry beam to the one end of the Gantry beam, which is arranged in the vicinity of the lateral guide surface. The arrangement of the lateral guide surface (i.e. laterally next to the Gantry beam in the vicinity of one of the ends of the Gantry beam at a distance from this one end of the Gantry beam) provides for a maximization of the dynamic bending stiffness of the Gantry beam in response to an acceleration of the movable table in the second direction (corresponding to the longitudinal direction of the Gantry beam). The latter is associated with the fact that, the larger the distance between the location at which the Gantry beam is guided on the one lateral guide surface by means of the lateral air bearing, and the center of mass of the movable table arranged on the Gantry beam, the larger the bending moment becomes, which acts on the Gantry beam or the lateral air bearing, respectively, in response to an acceleration of the movable table in the second direction, which reduces the bending stiffness of the Gantry beam and lengthens, in a disadvantageous manner, the setting time, which the Gantry beam requires in order to reach a stable position again after an acceleration of the movable table in the second direction. To balance tolerances and different speeds of the two linear drives of the two first linear axes in response to a movement of the Gantry beam in the first direction, the lateral air bearing is connected to the one end of the Gantry beam via a solid body joint (which is placed between the lateral air bearing and the one end of the Gantry beam) in such a way that the lateral air bearing can be pivoted relative to the Gantry beam.

The solid body joint comprises, inter alia, a relatively thin first web part, which extends essentially parallel to the second direction and parallel to a third direction, which extends perpendicular to the first direction and perpendicular to the second direction. This first web part is flexible in such a way that, with respect to a bending about an axis extending in the third direction, it has a small stiffness, so that the first web part of the solid body joint provides for a rotation of the lateral air bearing relative to the Gantry beam about an axis extending in the third direction. The solid body joint additionally comprises a relatively thin second web part, which extends essentially parallel to the first direction and parallel to the second direction. This second web part is flexible in such a way that, with respect to a bending about an axis extending in the first direction, it has a small stiffness, so that the second web part of the solid body joint provides for a rotation of the lateral air bearing relative to the Gantry beam about an axis extending in the first direction.

The positioning device known from the publication CN 113977294 A has the disadvantage that-compared to the distances, over which the movable element to be positioned can be moved relative to the flat guide surface of the base by means f the respective positioning devices, has a relatively large space requirement (with respect to a base surface parallel to the first direction and to the second direction, over which the respective parts of the positioning device are arranged so as to be spatially distributed), inter alia due to the spatial arrangement of the two first linear axes and of the second linear axis and the spatial arrangement of the lateral air bearing for guiding the Gantry beam on the one lateral guide surface, which is arranged laterally next to the Gantry beam in the vicinity of one of the ends of the Gantry beam at a distance from this one end of the Gantry bean.

In the case of the positioning device known from the publication CN 113977294 A, the above-mentioned solid body joint furthermore forms a connection between the lateral air bearing and the Gantry beam, which has a relatively small stiffness with respect to a rotation of the lateral air bearing relative to the Gantry beam about an axis extending in the first direction or about an axis extending in the second direction and additionally has a small stiffness with respect to a translation of the lateral air bearing relative to the Gantry beam in the first direction or in the second direction. The connection between the lateral air bearing and the Gantry beam formed by means of the solid body joint can thus be deformed relatively strongly in response to mechanical stresses of the Gantry beam, which induces a rotation of the Gantry beam relative to the lateral air bearing about an axis extending in the first direction or about an axis extending in the second direction or a translation of the Gantry beam relative to the lateral air bearing in the first direction or in the second direction. The latter is limiting in the case of highly-dynamic applications, in the case of which the Gantry beam is subjected to mechanical stresses of the above-mentioned type when the movable table is to be moved in the first direction and/or in the second direction with a largest possible acceleration.

### SUMMARY OF THE INVENTION

The present invention is based on the object of avoiding the mentioned disadvantages and to create a rotary joint arrangement, which comprises a first part, a second part and a coupling means comprising at least one solid body joint for connecting the first part and the second part in such a way that the second part can be rotated relative to the first part about an axis of rotation extending in a first direction, wherein the coupling means is to in particular provide for a compact arrangement of the first part and of the second part with a smaller space requirement and is to additionally ensure a relatively high stiffness of the coupling means with respect to a rotation of the first part relative to the second part about at least one direction extending perpendicular to the axis of rotation.

A positioning device is to additionally be provided, which comprises the rotary joint arrangement in combination with a linear guide device.

This object is solved by means of a rotary joint arrangement with the features of patent claim 1 and by means of a positioning device with the features of patent claim 13.

The rotary joint arrangement comprises a first part, a second part and a coupling means comprising at least one solid body joint for connecting the first part and the second part in such a way that the second part can be rotated relative to the first part about an axis of rotation extending in a first direction, wherein the first part and the second part each have an extension perpendicular to the axis of rotation, wherein the second part is arranged relative to the first part so as to be offset by a distance axially to the axis of rotation.

According to the invention, the coupling means has a first solid body joint and a second solid body joint. The first solid body joint consists of a first elongate solid body, which extends perpendicular to the first direction along a first plane parallel to the first direction, and which has a longitudinal axis arranged perpendicular to the first direction, wherein the first elongate solid body has the following longitudinal sections, which are arranged one behind another in the direction of the longitudinal axis of the first elongate solid body:
a first end section, which forms a first end of the first elongate solid body;
a second end section, which forms a second end of the first elongate solid body located opposite the first end of the first elongate solid body in the direction of the longitudinal axis of the first elongate solid body;
a central section arranged between the first end section and the second end section of the first elongate solid body;
a first web part arranged between the first end section and the central section of the first elongate solid body, connected to the first end section and the central section;
a second web part arranged between the second end section and the central section of the first elongate solid body, connected to the second end section and the central section of the first elongate solid body.

The second solid body joint consists of a second elongate solid body, which extends perpendicular to the first direction along a second plane parallel to the first direction, and which has a longitudinal axis arranged perpendicular to the first direction, wherein the second elongate solid body has the following longitudinal sections, which are arranged one behind another, in the direction of the longitudinal axis of the second elongate solid body:
a first end section, which forms a first end of the second elongate solid body;
a second end section, which forms a second end of the second elongate solid body located opposite the first end of the second elongate solid body in the direction of the longitudinal axis of the second elongate solid body;
a central section arranged between the first end section and the second end section of the second elongate solid body;
a first web part arranged between the first end section and the central section of the second elongate solid body, connected to the first end section and the central section;
a second web part arranged between the second end section and the central section of the second elongate solid body, connected to the second end section and the central section of the second elongate solid body.

The first part is thereby connected to the second part via the first solid body joint and the second solid body joint in such a way that the first end section of the first elongate solid body and the second end section of the first elongate solid body are rigidly connected to the second part, and the central section of the first elongate solid body is rigidly connected to the first part and that the first end section of the second elongate solid body and the second end section of the second elongate solid body are rigidly connected to the second part, and the central section of the second elongate solid body is rigidly connected to the first part, wherein the first plane and the second plane are inclined relative to one another in such a way that the first plane and the second plane form a common intersection line, which extends parallel to the first direction.

The first web part and the second web part of the first elongate solid body of the first solid body joint each have an extension perpendicular to the first plane, which is smaller than an extension of the first end section of the first elongate solid body perpendicular to the first plane, an extension of the second end section of the first elongate solid body perpendicular to the first plane and an extension of the central section the first elongate solid body perpendicular to the first plane, so that the first web part and the second web part of the first elongate solid body are elastically deformable and the central section of the first solid body joint can be moved relative to the first end section of the first solid body joint and to the second end section of the first solid body joint.

The first web part and the second web part of the second elongate solid body of the second solid body joint each have an extension perpendicular to the second plane, which is smaller than an extension of the first end section of the second elongate solid body perpendicular to the second plane, an extension of the second end section of the second elongate solid body perpendicular to the second plane and an extension of the central section of the second elongate solid body perpendicular to the second plane, so that the first web part and the second web part of the second elongate solid body are elastically deformable, and the central section of the second solid body joint can be moved relative to the first end section of the second solid body joint and to the second end section of the second solid body joint.

The first part and the second part are thereby connected by means of the first solid body joint and the second solid body joint in such a way that the second part is rotatably mounted on the first part about the common intersection line of the first plane and of the second plane by means of the first solid body joint and of the second solid body joint.

The use of the solid body joints provides for a friction-free and play-free relative movement between the first part and the second part of the rotary joint arrangement and provides a simple option for changing the arrangement of the first part relative to the second part in a precisely controllable and reproducible manner.

For the sake of simplicity, the first solid body joint and the second solid body joint can be formed identically, in particular with respect to the shape of the solid body joints and with respect to the material, of which the solid body joints are made (e.g. of steel).

The coupling means consisting of the first solid body joint and the second solid body joint ensures a connection between the first part and second part in such a way that the common intersection line of the first plane and of the second plane form a virtual axis of rotation, about which the first part can be rotated relative to the second part. The spatial position of the axis of rotation relative to the first part or to the second part, respectively, is therefore significantly determined by the spatial position of the first plane and of the second plane.

The rotary joint arrangement thus provides the option of suitably selecting the spatial position of the axis Of rotation relative to the first part and to the second part, as needed: Depending on which spatial position of the axis of rotation relative to the first part and to the second part is desired with respect to a specific application of the rotary joint arrangement, the spatial positions of the first solid body joint and of the second solid body joint can be selected relative to one another and relative to the first part and to the second part, in order to realize the spatial position of the axis of rotation.

Due to the fact that the second part is arranged relative to the first part so as to be offset by a distance axially to the axis of rotation, it is attained that the first part and the second part are arranged one behind the other in a row with respect to the axis of rotation. In this way, the rotary joint arrangement ensures a space-saving arrangement of the first part and of the second part with respect to the spatial extension of the rotary joint arrangement radially to the axis of rotation.

The first solid body joint and the second solid body joint of the coupling means are connected to the first part and the second part in such a way that the two end sections (or the first end section and the second end section, respectively) of the first solid body joint as well as the two end sections (or the first end section and the second end section, respectively) of the second solid body joint are rigidly connected to the second part of the rotary joint arrangement, while the central section of the first solid body joint as well as the central section of the second solid body joint are rigidly connected to the first part of the rotary joint arrangement. This formation of the coupling means has the effect that in response to a movement of the first part relative to the second part, the central section of the first solid body joint has to inevitably be moved relative to the two end sections of the first solid body joint, which are rigidly connected to the second part as well as the central section of the second solid body joint has to inevitably be moved relative to the two end sections of the second solid body joint, which are rigidly connected to the second part. The above-mentioned movement of the central section of the first solid body joint relative to the two end sections of the first solid body joint, which are rigidly connected to the second part, requires that during the movement of the central section of the first solid body joint, the first web part as well as the second web part of the first solid body joint are elastically deformed. The above-mentioned movement of the central section of the second solid body joint relative to the two end sections of the second solid body joint, which are rigidly connected to the first part, accordingly requires that during the movement of the central section of the second solid body joint, the first web part as well as the second web part of the second solid body joint are elastically deformed.

The first solid body joint of the coupling means is connected to the first part and the second part of the rotary joint arrangement in such a way that the first solid body joint forms a connection between the first part and the second part, which has a relatively small stiffness with respect to a rotation of the first part relative to the second part about the first direction and with respect to a translation of the first part relative to the second part perpendicular to the first plane (compared to a stiffness of this connection between the first part and the second part with respect to a translation of the first part relative to the second part in a direction parallel to the first plane).

The second solid body joint of the coupling means is accordingly connected to the first part and the second part of the rotary joint arrangement in such a way that the second solid body joint forms a connection between the first part and the second part, which has a relatively small stiffness with respect to a rotation of the first part relative to the second part about the first direction and with respect to a translation of the first part relative to the second part perpendicular to the second plane (compared to a stiffness of this connection between the first part and the second part with respect to a translation of the first part relative to the second part in a direction parallel to the second plane).

The arrangement of the first solid body joint and of the second solid body joint, in combination with one another, is to ensure that the first part is rotatably arranged on the second part in such a way that the arrangement of the first solid body joint and of the second solid body joint, in combination with one another, has a smallest possible rotational stiffness with respect to a rotation of the first part relative to the second part about the common intersection line of the first plane and of the second plane (which extends in the first direction).

The respective stiffnesses of the coupled system formed from the first part, the second part, the first solid body joint and the second solid body joint with respect to a rotation of the first part relative to the second part about the first direction and with respect to a translation of the first part relative to the second part along an axis extending perpendicular to the first direction or with respect to a rotation of the first part relative to the second part about an axis extending perpendicular to the first direction depend on the arrangement of the first solid body joint and of the second solid body joint relative to one another and in particular on the size of the incline of the first plane with respect to the second plane. The size of the incline of the first plane with respect to the second plane can therefore be suitably selected in order to suitably select the respective stiffnesses as needed.

The first solid body joint and the second solid body joint can be formed so that the spatial extension of the first solid body joint and the spatial extension of the second solid body joint are relatively small compared to the spatial extension of the first part and of the second part of the rotary joint arrangement. The first solid body joint and the second solid body joint can thus be provided in such a way that the arrangement of the first solid body joint and of the second solid body joint requires relatively little space and thus represents a compact connection between the first part and the second part of the rotary joint arrangement.

A smallest possible rotational stiffness of the arrangement of the first solid body joint and of the second solid body joint in combination with one another with respect to a rotation of the first part relative to the second part about the first direction additionally has the advantage that jointly, the first part and the second part form a system, which is coupled by means of the first solid body joint and the second solid body joint and which has a small natural frequency (e.g. in the range of less than 30 Hz) with respect to a rotation of the first part relative to the second part about the first direction. The small natural frequency is advantageous in this case with respect to the dynamic behavior of the rotary joint arrangement in response to an accelerated movement of the rotary joint arrangement in a second and/or third direction perpendicular to the first direction, for example with respect to the control of drives, which serve the purpose of moving the rotary joint arrangement in a second and/or third direction perpendicular to the first direction. This advantage is relevant, for example, with respect to applications, in which a part of the rotary joint arrangement (i.e. the first part or alternatively the second part of the rotary joint arrangement) is guided by means of a linear guide in such a way that this part can be moved linearly in a second direction perpendicular to the first direction, and the respective other part (i.e. the second part or alternatively the first part of the rotary joint arrangement) is connected by means of several drives for moving the respective other part in the second direction. A smallest possible rotational stiffness of the arrangement of the first solid body joint and of the second solid body joint is advantageous in this case because the several drives do not have to drive the respective other part perfectly synchronously in this case but can instead be controlled independently of one another within certain tolerances.

With respect to the dynamic behavior of the rotary joint arrangement in response to an accelerated movement of the rotary joint arrangement in a second and/or third direction perpendicular to the first direction, it would otherwise be advantageous that the first part and the second part, together form a system, which is coupled by means of the first solid body joint and the second solid body joint, and which in each case has a large stiffness in response to an accelerated movement of the first part and of the second part in a second and/or third direction perpendicular to the first direction with respect to a translation of the first part relative to the second part in the first direction and/or in the second direction and/or in the third direction and with respect to a rotation of the first part relative to the second part about a second and/or third direction perpendicular to the first direction. A large stiffness of the coupled system formed from the first part, the second part, the first solid body joint and the second solid body joint with respect to a translation of the first part relative to the second part in the first direction and/or in the second direction and/or in the third direction and with respect to a rotation of the first part relative to the second part about a second and/or third direction perpendicular to the first direction provide for a quicker regulation of drives for moving the rotary joint arrangement about a second and/or third direction perpendicular to the first direction, improve the vibration behavior of the first part or of the second part, respectively, in response to an accelerated movement of the first part and/or of the second part in the first direction and in response to an accelerated movement of the movable element in a second and/or third direction perpendicular to the first direction and provides for a higher accuracy of a positioning of the rotary joint arrangement by means of drives.

In one embodiment of the rotary joint arrangement, the first solid body joint or the second solid body joint, respectively, is formed in such a way that, in an undeformed state of the first solid body joint, the first solid body joint is formed symmetrically to the first plane, and/or, in an undeformed state of the second solid body joint, the second solid body joint is formed symmetrically to the second plane.

A symmetrical formation of the first solid body joint or of the second solid body joint, respectively, provides for a relatively simple production and a compact arrangement of the respective solid body joint with a small space requirement.

The arrangement of the first solid body joint and of the second solid body joint thereby has the technical effect that the second part is held in a rest position with respect to the first part by means of the first solid body joint and the second solid body joint in such a way that the second part can be moved out of the rest position by means of a rotation relative to the first part about the common intersection line of the first plane and of the second plane. The second part is thereby in the rest position when the first solid body joint and the second solid body joint are each in an undeformed state, so that each of the central sections of these solid body joints is in each case held in a stable position relative to the first end section and to the second end section of the first solid body joint or of the second solid body joint, respectively. If the second part is moved out of the rest position by means of a rotation relative to the first part, the web parts of the first solid body joint and of the second solid body joint are deformed elastically, so that the first solid body joint and the second solid body joint, together generate a restoring force acting on the second part, which counteracts the movement of the second part out of the rest position.

Another embodiment of the rotary joint arrangement is formed in such a way that: in the first direction, the first end section of the first elongate solid body of the first solid body joint has an extension, which is larger than the extension of the first end section of the first elongate solid body perpendicular to the first plane; and/or in the first direction, the second end section of the first elongate solid body of the first solid body joint has an extension, which is larger than the extension of the second end section of the first elongate solid body perpendicular to the first plane; and/or in the first direction, the central section of the first elongate solid body of the first solid body joint has an extension, which is larger than the extension of the central section of the first elongate solid body perpendicular to the first plane; and/or, in the first direction, the first web part of the first elongate solid body of the first solid body joint has an extension, which is larger than the extension of the first web part of the first elongate solid body perpendicular to the first plane; and/or in the first direction, the second web part of the first elongate solid body of the first solid body joint has an extension, which is larger than the extension of the second web part of the first elongate solid body perpendicular to the first plane; and/or in the first direction, the first end section of the second elongate solid body of the second solid body joint has an extension, which is larger than the extension of the first end section of the second elongate solid body perpendicular to the second plane; and/or in the first direction, the second end section of the second elongate solid body of the second solid body joint has an extension, which is larger than the extension of the second end section of the second elongate solid body perpendicular to the second plane; and/or in the first direction, the central section of the second elongate solid body of the second solid body joint has an extension, which is larger than the extension of the central section of the second elongate solid body perpendicular to the second plane; and/or in the first direction, the first web part of the second elongate solid body of the second solid body joint has an extension, which is larger than the extension of the first web part of the second elongate solid body perpendicular to the second plane; and/or in the first direction, the second web part of the second elongate solid body of the second solid body joint has an extension, which is larger than the extension of the second web part of the second elongate solid body perpendicular to the second plane.

Due to the above-mentioned formation of the first solid body joint or of the second solid body joint, respectively, the coupling means forms a connection between the first part and the second part of the rotary joint arrangement, which has a relatively high stiffness with respect to a translation of the first part relative to the second part in the first direction (according to the axis of rotation of the rotary joint arrangement) and with respect to a rotation of the first part relative to the second part about an axis, which is directed perpendicular to the first direction.

Another embodiment of the rotary joint arrangement is characterized in that, in an undeformed state of the first solid body joint, the first solid body joint, and, in an undeformed state of the second solid body joint, the second solid body joint are arranged relative to one another in such a way that the first solid body joint and the second solid body joint are arranged symmetrically with respect to a third plane, which extends parallel to the first direction, wherein the common intersection line of the first plane and of the second plane extends in the third plane.

In the case of this arrangement of the first solid body joint and of the second solid body joint, the first part and the second part form a system, which is coupled by means of the coupling means and which has a particularly large stiffness with respect to a translation of the first part relative to the second part along an axis, which extends parallel to the third plane and perpendicular to the first direction.

It is furthermore attained that in response to a translation of the first part relative to the second part along an axis, which extends parallel to the third plane and perpendicular to the first direction, the first solid body joint and the second solid body joint are each mechanically stressed and therefore deformed in the same way. This prevents that the coupling means could provide for a rotation of the first part relative to the second part about the first direction in response to a mechanical stress, which induces a translation of the first part relative to the second part parallel to the third plane and perpendicular to the first direction, and thus provides, for example, a stabilization of the spatial position of the first part relative to the second part in response to a dynamic stress of the rotary joint arrangement, which induces a translation of the above-mentioned type of the first part relative to the second part.

One embodiment of the rotary joint arrangement is formed in such a way that the first solid body joint is arranged relative to the second solid body joint in such a way that the first solid body joint has a distance from the second solid body joint perpendicular to the first direction. This distance can be suitably selected in order to be able, for example, to connect the first solid body joint and the second solid body joint to the first part and the second part of the rotary joint arrangement in a simple way (for example depending on the respective shape of the first part or of the second part, respectively), and to additionally define the spatial position of the axis of rotation of the rotary joint arrangement as needed with respect to the first part and the second part.

One embodiment of the rotary joint arrangement is formed in such a way that the second part has a first elongate hollow space, which, in the first direction, extends along the first plane, and the first solid body joint is arranged in the first elongate hollow space in such a way that, in the first direction, the first solid body joint extends through the first elongate hollow space at least over a portion of its extension in the first direction. The second part can accordingly have a second elongate hollow space, which, in the first direction, extends along the second plane, wherein the second solid body joint is arranged in the second elongate hollow space in such a way that, in the first direction, the second solid body joint extends through the second elongate hollow space at least over a portion of its extension in the first direction.

This design of the second part offers the possibility of integrating the first solid body joint and/or the second solid body joint into the second part, so that the first solid body joint and/or the second solid body joint do not protrude or protrude at best only by a relatively small distance in the first direction from the respective hollow space. The first part and the second part can be connected to one another in this way via the first solid body joint and/or the second solid body joint in such a way that the rotary joint arrangement as a whole has a relatively small installation height in the direction of the axis of rotation.

In a further development of the above-mentioned embodiment, it can be provided that the first elongate hollow space extends along the first plane in such a way that a longitudinal axis of the first elongate hollow space is arranged parallel to the first plane and perpendicular to the first direction, and the first elongate hollow space is limited laterally with respect to the first plane by means of two side walls of the second part, which are located opposite one another and which each extend in the first direction parallel to the first plane and have a distance relative to one another in a direction perpendicular to the first plane. It can be provided accordingly that the second elongate hollow space extends along the second plane in such a way that a longitudinal axis of the second elongate hollow space is arranged parallel to the second plane and perpendicular to the first direction, and the second elongate hollow space is limited laterally with respect to the second plane by two side walls of the second part, which are located opposite one another and which each extend in the first direction parallel to the second plane and which have a distance relative to one another in a direction perpendicular to the second plane. The first hollow space and the second hollow space can each be produced in a simple way and provide for a simple, space-saving integration of the first solid body joint or of the second solid body joint, respectively, into the second part.

In another further development of the above-mentioned embodiment, it can be provided that the two side walls of the second part, which are located opposite one another and which laterally limit the first elongate hollow space with respect to the first plane, are formed in such a way that they enclose the first end section and the second end section of the first solid body joint, so that the first end section and the second end section of the first solid body joint are connected in a positive manner to the second part.

The above-mentioned shape of the side walls of the first elongate hollow space makes it possible to realize a rigid connection between the first end section of the first solid body joint and the second part, and a rigid connection between the second end section of the first solid body joint and the second part in a simple way. The side walls of the first elongate hollow space can be formed, for example, in such a way that the first end section of the first solid body joint and the second end section of the first solid body joint are each held in a positive manner between the side walls of the first elongate hollow space over the entire length of the extension of the first end section or of the second end section, respectively, in the direction of the axis of rotation of the rotary joint arrangement. In this way, the first end section and the second end section of the first solid body joint can be firmly connected to the second part in such a way that the first end section and the second end section of the first solid body joint cannot be deformed in response to a movement of the first part relative to the second part.

The two side walls of the second part, which are located opposite one another and which laterally limit the second elongate hollow space with respect to the second plane, can be formed in such a way that they enclose the first end section and the second end section of the second solid body joint, so that the first end section and the second end section of the second solid body joint are connected in a positive manner to the second part.

The above-mentioned shape of the side walls of the second elongate hollow space makes it possible to realize a rigid connection between the first end section of the second solid body joint and the second part, and a rigid connection between the second end section of the second solid body joint and the second part in a simple way. The side walls of the second elongate hollow space can be formed, for example, in such a way that the first end section of the second solid body joint and the second end section of the second solid body joint are each held in a positive manner between side walls of the second elongate hollow space over the entire length of the extension of the first end section of the second end section, respectively, in the direction of the axis of rotation of the rotary joint arrangement. In this way, the first end section and the second end section of the second solid body joint can be firmly connected to the second part in such a way that the first end section and the second end section of the second solid body joint cannot be deformed in response to a movement of the first part relative to the second part.

The rotary joint arrangement can comprise one or several stop elements, which serve as mechanical stops in order to limit a rotation of the second part relative to the first part about the axis of rotation. For this purpose, the second part can have, for example, at least one stop element, which is arranged in such a way that the stop element has a distance from the central section of the first solid body joint, when the second part is arranged in the rest position relative to the first part, and which stop element can be brought into contact with the central section of the first solid body joint by means of a rotation of the second part about a specified maximum angle of rotation about the common intersection line of the first plane and of the second plane, so that the central section of the first solid body joint forms a mechanical stop for the second part, which limits the rotation of the second part. Alternatively or additionally, the second part can have at least one stop element, which is arranged in such a way that the stop element has a distance from the central section of the second solid body joint, when the second part is arranged in the rest position relative to the first part, and which stop element can be brought into contact with the central section of the second solid body joint by means of a rotation of the second part about a specified maximum angle of rotation about the common intersection line of the first plane and of the second plane, so that the central section of the second solid body joint forms a mechanical stop for the second part, which limits the rotation of the second part. A mechanical overload of the first solid body joint and of the second solid body joint can be avoided in this way.

In another further development of the above-mentioned embodiment, it can be provided that the two side walls of the second part, which are located opposite one another and which laterally limit the first elongate hollow space with respect to the first plane, are formed in such a way that they enclose the central section of the first solid body joint, wherein, perpendicular to the first plane, the two side walls of the second part, which are located opposite one another and which laterally limit the first elongate hollow space with respect to the first plane, have a distance perpendicular to the first plane, which is larger than an extension the central section of the first solid body joint perpendicular to the first plane, so that the central section of the first solid body joint can be moved relative to the second part.

The above-mentioned shape of the side walls of the first elongate hollow space makes it possible that the first part and the second part of the rotary joint arrangement can be rotated relative to one another about the axis of rotation, provided that, in response to the rotation of the first part relative to the second part, the central section of the first solid body joint does not abut against one of the two side walls of the second part, which are located opposite one another and which laterally limit the first elongate hollow space with respect to the first plane. Each of the two side walls of the second part, which are located opposite one another and which laterally limit the first elongate hollow space with respect to the first plane, thus form a mechanical stop for the central section of the first solid body joint and thus limit an angle of rotation, about which the first part can be rotated relative to the second part about the axis of rotation of the rotary joint arrangement. Additionally or alternatively, it can be provided that the two side walls of the second part, which are located opposite one another and which laterally limit the second elongate hollow space with respect to the second plane, are formed in such a way that they enclose the central section of the second solid body joint, wherein, perpendicular to the second plane, the two side walls of the second part, which are located opposite one another and which laterally limit the second elongate hollow space with respect to the second plane, have a distance perpendicular to the second plane, which is larger than an extension of the central section of the second solid body joint perpendicular to the second plane, so that the central section of the second solid body joint can be moved relative to the second part.

The above-mentioned shape of the side walls of the first elongate hollow space or of the second elongate hollow space, respectively, make it possible that the first part and the second part of the rotary joint arrangement can be rotated relative to one another about the axis of rotation, provided that, in response to the rotation of the first part relative to the second part, the central section of the second solid body joint does not abut against one of the two side walls of the second part, which are located opposite one another and which laterally limit the second elongate hollow space with respect to the second plane. Each of the two side walls of the second part, which are located opposite one another and which laterally limit the second elongate hollow space with respect to the second plane, thus form a mechanical stop for the central section of the second solid body joint and thus limit an angle of rotation, about which the first part can be rotated relative to the second part about the axis of rotation of the rotary joint arrangement.

One embodiment of the rotary joint arrangement is formed in such a way that the central section of the first solid body joint can be moved relative to the second part in a translatory movement perpendicular to the first plane and/or the central section of the first solid body joint can be moved relative to the second part by means of a rotation about an axis of rotation extending in the first direction. It can be provided analogously that the central section of the second solid body joint can be moved relative to the second part in a translatory movement perpendicular to the second plane and/or the central section of the second solid body joint can be moved relative to the second part by means of a rotation about an axis of rotation extending in the first direction. Due to the fact that the central section of the first solid body joint and the central section of the second solid body joint can be moved in the above-mentioned way, it is ensured that the first part can be rotated relative to the second part of the rotary joint arrangement about the axis of rotation of the rotary joint arrangement, which extends in the first direction.

One embodiment of the rotary joint arrangement is formed in such a way that the first plane and the second plane are inclined relative to one another in such a way that the first plane and the second plane intersect in the common intersection line at an angle, which is larger than or equal to 10° and smaller than or equal to 120°.

In the case of this embodiment, it is ensured that the coupled system formed from the first part, the second part, the first solid body joint and the second solid body joint has a relatively small stiffness with respect to a rotation of the first part relative to the second part about the first direction and additionally has a relatively large stiffness, which is sufficiently large for a plurality of applications, with respect to a translation of the first part relative to the second part along an axis extending perpendicular to the first direction or with respect to a rotation of the first part relative to the second part about an axis extending perpendicular to the first direction.

The coupled system formed from the first part, the second part, the first solid body joint and the second solid body joint accordingly has a relatively small natural frequency with respect to vibrations of the coupled system, which are based on a rotation of the first part relative to the second part about the first direction, and relatively high natural frequencies with respect to vibrations of the coupled system, which are based on a translation of the first part relative to the second part along an axis extending perpendicular to the first direction or on a rotation of the first part relative to the second part about an axis extending perpendicular to the first direction. This is advantageous with respect to the transient response of the rotary joint arrangement in dynamic applications, in which the rotary joint arrangement as a whole has to be moved with a large acceleration.

One embodiment can be formed in such a way that the first plane and the second plane are inclined relative to one another in such a way that the first plane and the second plane intersect in the common intersection line at an angle, which is larger than or equal to 30° and smaller than or equal to 90°.

In the case of this embodiment, it is ensured that the coupled system formed from the first part, the second part, the first solid body joint and the second solid body joint has a particularly large stiffness with respect to translation of the: first part relative to the second part along an axis extending perpendicular to the first direction or with respect to a rotation of the first part relative to the second part about an axis extending perpendicular to the first direction.

The rotary joint arrangement according to the invention can be used in an advantageous manner as integral part of a positioning device for positioning a movable element, for example in such a way that the rotary joint arrangement serves as support structure for the movable element, which is to be positioned.

A corresponding positioning device can have, for example, a rotary joint arrangement according to the invention and a linear guide device for guiding the second part of the rotary joint arrangement, wherein the second part of the rotary joint arrangement is guided by means of the linear guide device in such a way that the second part can be moved linearly in a second direction, which extends perpendicular to the first direction. Due to the fact that the second part of the rotary joint arrangement is guided by means of the linear guide device, the rotary joint arrangement as a whole can be moved so as to be guided in the second direction, wherein the structure of the rotary joint arrangement makes it possible that the first part can be rotated relative to the second part about the axis of rotation, which extends in the first direction.

Alternatively, the positioning device can have a rotary joint arrangement according to the invention and a linear guide device for guiding the first part of the rotary joint arrangement, wherein the first part of the rotary joint arrangement is guided by means of the linear guide device in such a way that the first part can be moved linearly in a second direction, which extends perpendicular to the first direction.

The linear guide device can be realized by means of known technologies. For example, the second part can be guided on a guide surface or guide rail by means of rolling bodies, the second part can alternatively be guided on a guide surface by means of a sliding bearing or air bearing.

One embodiment of the positioning device is formed in such a way that it is equipped with at least one linear drive, which is connected to the first part of the rotary joint arrangement, for moving the first part in the second direction. Several linear drives, which are connected to the first part of the rotary joint arrangement, for moving the first part can also be present, which can be arranged so as to be spatially distributed and which can be controlled independently of one another. For example, linear motors are suitable as linear drives of the positioning device. The positioning device can be formed, for example, in such a way that each linear drive is a linear motor. Linear drives of another design are generally likewise suitable, for example linear drives comprising threaded spindle or ball or roller screw drive.

A further development of the above-mentioned embodiment of the positioning device comprises a base comprising at least one flat guide surface and/or a guide beam comprising at least one flat guide surface, wherein the second part is guided by means of at least one air bearing on the flat guide surface of the base and/or on the flat guide surface of the guide beam. The rotary joint arrangement ensures that the second part, together with the at least one air bearing, can be rotated relative to the first part about the axis of rotation, which extends in the first direction. The spatial position of the air bearing relative to the first part can be changed in this way, for example in order to compensate tolerances with respect to the arrangement of the first part relative to the flat guide surface or to the guide beam, respectively. It can be avoided in this way that, in response to a movement of the rotary joint arrangement in the second direction, the air bearing comes into contact with the flat guide surface or with the guide beam, respectively, and could be damaged thereby.

One embodiment of the positioning device can alternatively be designed in such a way that the first part is guided by means of the linear guide device and that at least one linear drive is present, which is connected to the second part of the rotary joint arrangement, for moving the second part in the second direction.

In a further development of this embodiment of the positioning device, the linear guide device can comprise a base comprising at least one flat guide surface and/or a guide beam comprising at least one flat guide surface, and the first part can be guided on the flat guide surface of the base and/or on the flat guide surface of the guide beam by means of at least one air bearing.

### BRIEF DESCRIPTION OF THE DRAWINGS

Further details of the invention and in particular exemplary embodiments of the rotary joint arrangement according to the invention and of the positioning device according to the invention will be described below on the basis of the enclosed drawings, in which:

FIG. 1 shows a perspective view of a rotary joint arrangement according to the invention, comprising a first part, a second part and a coupling means for connecting the first part and the second part in such a way that the second part can be rotated relative to the first part about an axis of rotation DZ, wherein the coupling means comprises an arrangement of two solid body joints, in an exploded illustration, in which the individual parts of the rotary joint arrangement are separated from one another in the direction of the axis of rotation DZ;

FIG. 2 shows the rotary joint arrangement according to FIG. 1, in a side view in a direction, which extends perpendicular to the axis of rotation DZ;

FIG. 3 shows the rotary joint arrangement DGA according to FIG. 1, in a top view in a direction, which extends along the axis of rotation DZ;

FIG. 4A shows a perspective view of one of the two solid body joints according to FIG. 1;

FIG. 4B shows the solid body joint according to FIG. 4A, in a top view in the direction of the axis of rotation DZ;

FIG. 4C shows the solid body joint according to FIG. 4B, in a side view in a direction perpendicular to the symmetry plane ME1 or ME2, respectively, illustrated in FIG. 4B;

FIG. 5A shows the solid body joint according to FIG. 4A, in a top view in the direction of the axis of rotation DZ, wherein the solid body joint is in an undeformed state, with an illustration of two degrees of freedom of movement of a central section of the solid body joint relative to a first end section and to a second end section of the solid body joint;

FIG. 5B shows the solid body joint according to FIG. 5A, in a top view in the direction of the axis of rotation DZ, wherein the solid body joint is in a deformed state after a movement of the central section of the solid body joint relative to the first end section and to the second end section of the solid body joint according to a first degree of freedom of movement;

FIG. 5C shows the solid body joint according to FIG. 5A, in a top view in the direction of the axis of rotation DZ, wherein the solid body joint is in a deformed state after a movement the central section of the solid body joint relative to the first end section and to the second end section of the solid body joint according to a second degree of freedom of movement;

FIG. 6A shows a perspective view of a conventional solid body joint according to the prior art;

FIG. 6B shows the conventional solid body joint according to FIG. 6A, in a top view in the direction of an axis Z, in an undeformed state;

FIG. 6C shows the conventional solid body joint according to FIG. 6A, in a top view in the direction of an axis Z, in a deformed state;

FIG. 7 shows the second part of the rotary joint arrangement according to FIG. 1, in a top view in a direction Z, which extends along the axis of rotation DZ;

FIG. 8 shows the second part of the rotary joint arrangement according to FIG. 1 in a top view in a direction Z, which extends along the axis of rotation DZ, in an enlarged illustration;

FIG. 9 shows a positioning device comprising a rotary joint arrangement according to FIG. 1 and a linear guide device for guiding the second part of the rotary joint arrangement;

FIG. 10 shows a perspective view of parts of the positioning device according to FIG. 9, in an exploded illustration.

### DESCRIPTION OF EMBODIMENTS

Unless otherwise mentioned, the same reference numerals are in each case used for the same elements in the figures.

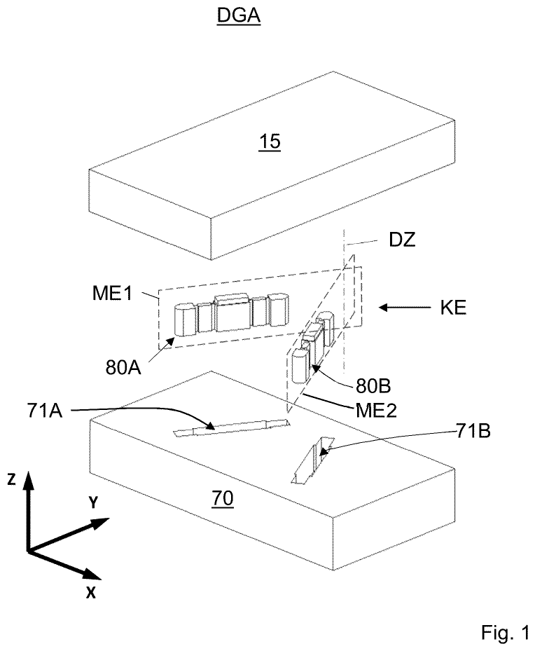

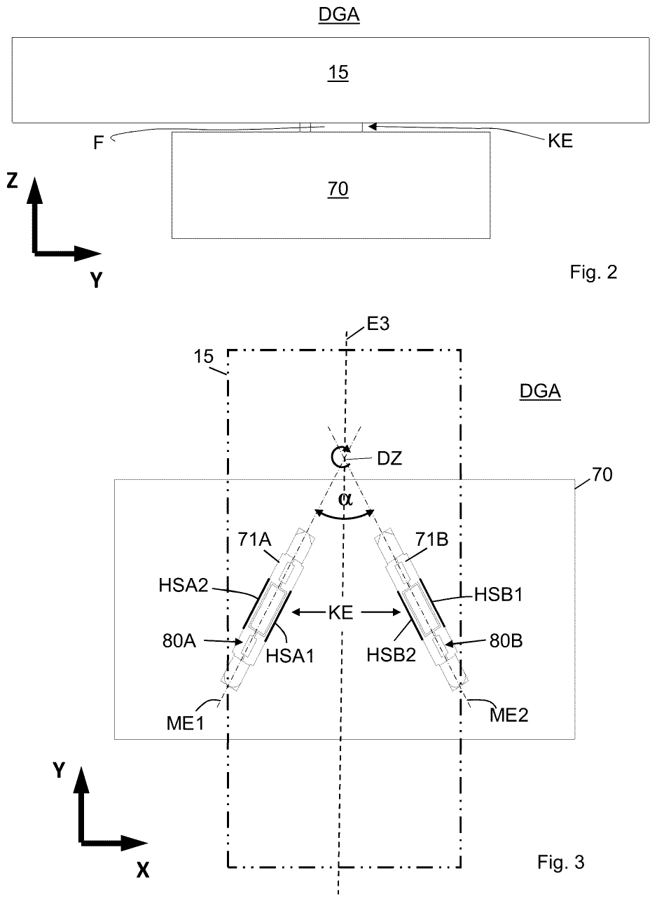

FIG. 1-3 show a rotary joint arrangement DGA according to the invention in different views from different perspectives. FIG. 1 thereby shows the rotary joint arrangement DGA in a perspective view with respect to a coordinate system illustrated in FIG. 1 with the three axes X, Y, Z (X-axis, Y-axis, Z-axis) (which are orthogonal relative to one another), FIGS. 2 and 3 show the same rotary joint arrangement DGA in views from other perspectives, in particular in a (side) view perpendicular to the Z-axis (in the present example along the X-axis) and in a top view along the Z-axis.

The rotary joint arrangement DGA comprises: a first part 15, a second part 70 and a coupling means KE for connecting the first part 15 and the second part 70 in such a way that the second part 70 can be rotated relative to the first part about an axis of rotation DZ, which extends in a first direction Z. The structure and function of the coupling means will be described in more detail below.

In the present example, the first part 15 and the second part 70 each have the shape of a cuboid. Alternatively, the first part 15 and the second part 70 can generally each be components with any shape.

The first part 15 and the second part 70 each have an extension perpendicular to the axis of rotation DZ, wherein the second part 70 is arranged relative to the first part 15 so as to be offset by a distance axially to the axis of rotation DZ.

In the present example, the coupling means KE has a first solid body joint 80A and a second solid body joint 80B.

FIG. 1 shows the rotary joint arrangement DGA in an exploded illustration, in which all details of the rotary joint arrangement DGA-in this case the first part 15, the second part 70 and the two solid body joints 80A and 80B of the coupling means KE-are separated from one another in the direction of the Z-axis. In contrast, FIG. 2 shows the rotary joint arrangement DGA in an assembled state, in which the first part 15 and the second part 70 are connected to one another via the two solid body joints 80A and 80B of the coupling means KE, which will be described in more detail below.

As suggested by FIGS. 1 and 3, a first elongate hollow space 71A and a second elongate hollow space 71B, which serve the purpose of receiving the first solid body joint 80A and the second solid body joint 80B, are formed in the second part 70 on a side facing the first part 15, so that (in an assembled state of the rotary joint arrangement DGA), at least one section of the first solid body joint 80A extends in the first elongate hollow space 71A and at least one section of the second solid body joint 80B extends in the second elongate hollow space 71B.

As can be seen from FIGS. 1-3 and 4A, the first solid body joint 80A consists of a first elongate solid body, which extends perpendicular to the first direction Z along a first plane ME1 parallel to the first direction Z, and which has a longitudinal axis, which is arranged perpendicular to the first direction Z, wherein the first elongate solid body has the following longitudinal sections, which are arranged one behind another in the direction of the longitudinal axis of the first elongate solid body:
a first end section E1, which forms a first end of the first elongate solid body;
a second end section E2, which forms a second end of the first elongate solid body, which is located opposite the first end of the first elongate solid body in the direction of the longitudinal axis of the first elongate solid body;
a central section F arranged between the first end section and the second end section of the first elongate solid body;
a first web part S1 arranged between the first end section E1 and the central section F of the first elongate solid body, connected to the first end section E1 and the central section F;
a second web part S2 arranged between the second end section E2 and the central section F, connected to the second end section E2 and the central section F of the first elongate solid body.

The second solid body joint 80B accordingly consists of a second elongate solid body, which extends perpendicular to the first direction Z along a second plane ME2 parallel to the first direction Z, and which has a longitudinal axis arranged perpendicular to the first direction Z, wherein the second elongate solid body has the following longitudinal sections, which are arranged one behind another, in the direction of the longitudinal axis of the second elongate solid body (FIGS. 1-3 and 4A):
a first end section E1, which forms a first end of the second elongate solid body;
a second end section E2, which forms a second end of the second elongate solid body located opposite the first end of the second elongate solid body in the direction of the longitudinal axis of the second elongate solid body;
a central section F arranged between the first end section and the second end section of the second elongate solid body;
a first web part S1 arranged between the first end section E1 and the central section F of the second elongate solid body, connected to the first end section E1 and the central section;
a second web part S2 arranged between the second end section E2 and the central section F of the second elongate solid body, connected to the second end section E2 and the central section F of the second elongate solid body.

The second part 70 is connected to the first part 15 via the first solid body joint 80A and the second solid body joint 80B in such a way that the first end section E1 of the first elongate solid body and the second end section E2 of the first elongate solid body are rigidly connected to the second part 70, and the central section F of the first elongate solid body is rigidly connected to the first part 15 and that the first end section E1 of the second elongate solid body and the second end section E2 of the second elongate solid body are rigidly connected to the second part 70, and the central section F of the second elongate solid body is rigidly connected to the first part 15.

The first plane ME1 and the second plane ME2 are inclined relative to one another in such a way that the first plane ME1 and the second plane ME2 form a common intersection line DZ, which extends parallel to the first direction Z (FIGS. 1, 3).

The first web part S1 and the second web part S2 of the first elongate solid body of the first solid body joint 80A each have an extension perpendicular to the first plane ME1, which is smaller than an extension of the first end section E1 of the first elongate solid body perpendicular to the first plane ME1, an extension of the second end section E2 of the first elongate solid body perpendicular to the first plane ME1 and an extension of the central section F of the first elongate solid body perpendicular to the first plane ME1, so that the first web part S1 and the second web part S2 of the first elongate solid body are elastically deformable, and the central section F of the first solid body joint 80A can be moved relative to the first end section E1 of the first solid body joint 80A and to the second end section E2 of the first solid body joint 80A.

The first web part S1 and the second web part S2 of the second elongate solid body of the second solid body joint 80B accordingly each have an extension perpendicular to the second plane ME2, which is smaller than an extension of the first end section E1 of the second elongate solid body perpendicular to the second plane ME2, an extension of the second end section E2 of the second elongate solid body perpendicular to the second plane ME2 and an extension of the central section F of the second elongate solid body perpendicular to the second plane ME2, so that the first web part S1 and the second web part S2 of the second elongate solid body are elastically deformable, and the central section F of the second solid body joint 80B can be moved relative to the first end section E1 of the second solid body joint 80B and to the second end section E2 of the second solid body joint 80B.

The arrangement of the first solid body joint 80A and of the second solid body joint 80B thereby have the effect that the second part 70 is rotatably mounted on the first part 15 about the common intersection line DZ of the first plane ME1 and of the second plane ME2 by means of the first solid body joint 80A and the second solid body joint 80B.

In the present example, the rotary joint arrangement DGA is formed in such a way that the first solid body joint 80A is formed symmetrically to the first plane ME1 in an undeformed state of the first solid body joint 80A, and the second solid body joint 80B is formed symmetrically to the second plane ME2 in an undeformed state of the second solid body joint 80B (FIGS. 1, 3 and 4B).

In the present example, the first solid body joint 80A and the second solid body joint 80B are formed identically.

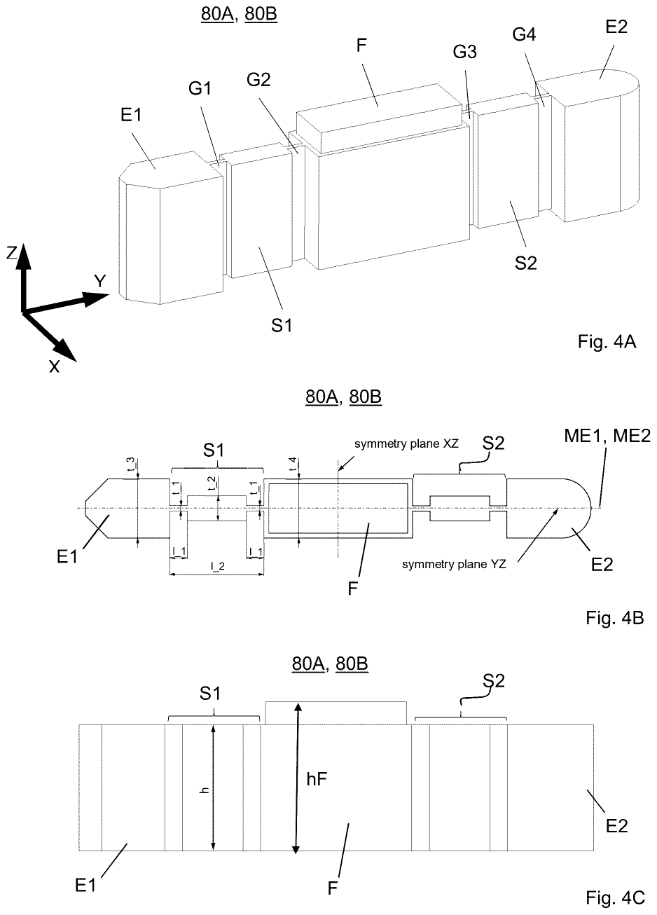

In the present example, the rotary joint arrangement (DGA) is additionally formed in such a way that (FIGS. 1, 4A, 4B, 4C):
in the first direction Z, the first end section E1 of the first elongate solid body of the first solid body joint 80A has an extension h, which is larger than the extension t_3 of the first end section E1 of the first elongate solid body perpendicular to the first plane ME1;
in the first direction Z, the second end section E2 of the first elongate solid body of the first solid body joint 80A has an extension h, which is larger than the extension t_3 of the second end section E2 Of the first elongate solid body perpendicular to the first plane ME1;
in the first direction Z, the central section F of the first elongate solid body of the first solid body joint 80A has an extension hF, which is larger than the extension t_4 of the central section F of the first elongate solid body perpendicular to the first plane ME1;
in the first direction Z, the first web part S1 of the first elongate solid body of the first solid body joint 80A has an extension h, which is larger than the extension t_2 of the first web part S1 of the first elongate solid body perpendicular to the first plane ME1;
in the first direction Z, the second web part S2 of the first elongate solid body of the first solid body joint 80A has an extension h, which is larger than the extension of the second web part S2 of the first elongate solid body perpendicular to the first plane ME1;
in the first direction Z, the first end section E1 of the second elongate solid body of the second solid body joint 80B has an extension h, which is larger than the extension t_3 of the first end section E1 of the second elongate solid body perpendicular to the second plane ME2;
in the first direction Z, the second end section E2 of the second elongate solid body of the second solid body joint 80B has an extension h, which is larger than the extension t_3 of the second end section E2 of the second elongate solid body perpendicular to the second plane ME2;
in the first direction Z, the central section F of the second elongate solid body of the second solid body joint 80B has an extension hF, which is larger than the extension t_4 of the central section F of the second elongate solid body perpendicular to the second plane ME2;
in the first direction Z, the first web part S1 of the second elongate solid body of the second solid body joint 80B has an extension h, which is larger than the extension t_2 of the first web part S1 of the second elongate solid body perpendicular to the second plane ME2;
in the first direction Z, the second web part S2 of the second elongate solid body of the second solid body joint 80B has an extension h, which is larger than the extension t_2 of the second web part S2 of the second elongate solid body perpendicular to the second plane ME2.

As suggested by FIGS. 1, 4A and 4B, the first web part S1 of the first solid body joint 80A or first web part S1 of the second solid body joint 80B, respectively, do not have to be formed in such a way that the extension of the first web part S1 of the first solid body joint 80A perpendicular to the first plane ME1 and the extension of the first web part S1 of the second solid body joint 80B perpendicular to the second plane ME2 are each constant over the entire extension 2 of the first web part S1 between the first end section E1 and the central section F along the longitudinal axis of the first solid body joint 80A or along the longitudinal axis of the second solid body joint 80B, respectively.

The second web part S2 of the first solid body joint 80A or second web part S2 of the second solid body joint 80B, respectively, accordingly do not have to be formed in such a way that the extension of the second web part S2 of the first solid body joint 80A perpendicular to the first plane ME1 and the extension of the second web part S2 of the second solid body joint 80B perpendicular to the second plane ME2 are each constant over the entire extension 1_2 of the second web part S2 between the second end section E2 and the central section F along the longitudinal axis of the first solid body joint 80A or along the longitudinal axis of the second solid body joint 80B, respectively.

As FIGS. 4A and 4B suggest, the first web part S1 of the first solid body joint 80A in the present example has a variable extension perpendicular to the first plane ME1, and the first web part S1 of the second solid body joint 80B has a variable extension perpendicular to the second plane ME2.

In the present example, the first web part S1 of the first solid body joint 80A or the first web part S1 of the second solid body joint 80B, respectively, in particular has three longitudinal sections, which are arranged one behind the other in the longitudinal direction of the solid body joint: a first thin longitudinal section G1 adjoining the first end section E1, a second thin longitudinal section G2 adjoining the central section F and a middle longitudinal section connecting the first thin longitudinal section G1 and the second thin longitudinal section G2.

The first thin longitudinal section G1 and the second thin longitudinal section G2 thereby have an extension 1_1 along the longitudinal axis of the first solid body joint 80A or along the longitudinal axis of the second solid body joint 80B, respectively.

In the present example, the first thin longitudinal section G1 and the second thin longitudinal section G2 of the first solid body joint 80A or of the second solid body joint 80B, respectively, each have an extension t_1 perpendicular to the first plane ME1 or perpendicular to the second plane ME2, respectively, which extension is smaller than the extension t_2 of the middle longitudinal section connecting the first thin longitudinal section G1 and the second thin longitudinal section G2 perpendicular to the first plane ME1 or perpendicular to the second plane ME2, respectively.

In the present example, the second web part S2 of the first solid body joint 80A or the second web part S2 of the second solid body joint 80B, respectively, accordingly has in particular three longitudinal sections, which are arranged one behind the other in the longitudinal direction of the solid body joint: a fourth thin longitudinal section G4 adjoining the second end section E2, a third thin longitudinal section G3 adjoining the central section F and a middle longitudinal section connecting the third thin longitudinal section G3 and the fourth thin longitudinal section G4.

The third thin longitudinal section G3 and the fourth thin longitudinal section G4 thereby have an extension 1_1 along the longitudinal axis of the first solid body joint 80A or along the longitudinal axis of the second solid body joint 80B, respectively.

In the present example, the third thin longitudinal section G3 and the fourth thin longitudinal section G4 of the first solid body joint 80A or of the second solid body joint 80B, respectively, each have an extension t_1 perpendicular to the first plane ME1 or perpendicular to the second plane ME2, which extension is smaller than the extension t_2 of the middle longitudinal section connecting the third thin longitudinal section G3 and the fourth thin longitudinal section G4 perpendicular to the first plane ME1 or perpendicular to the second plane ME2, respectively.

As can be seen from FIG. 3, the rotary joint arrangement DGA is formed in such a way in the present example that the first solid body joint 80A in an undeformed state of the first solid body joint 80A, and the second solid body joint 80B in an undeformed state of the second solid body joint 80B, are arranged relative to one another in such a way that the first solid body joint 80A and the second solid body joint 80B are arranged symmetrically with respect to a third plane E3, which extends parallel to the first direction Z, wherein the common intersection line DZ of the first plane ME1 and of the second plane ME2 extends in the third plane E3. It is thus attained that in response to a translation of the first part 15 relative to the second part 70 along an axis, which extends parallel to the third plane E3 and perpendicular to the first direction Z, the first solid body joint 80A and the second solid body joint 80B are each mechanically stressed in the same way and are deformed accordingly.

In the present example, the rotary joint arrangement DGA is formed in such a way that the first solid body joint 80A is arranged relative to the second solid body joint 80B in such a way that perpendicular to the first direction Z, the first solid body joint 80A has a distance from the second solid body joint 80B (FIG. 3). As can be seen from FIG. 3, the first solid body joint 80A and the second solid body joint 80B are arranged symmetrically to the third plane E3 and are thereby offset relative to one another by a distance perpendicular to the third plane E3 in the direction of the X-axis. This arrangement of the first solid body joint 80A and of the second solid body joint 80B has the effect that the rotary joint arrangement DGA has a relatively large stiffness with respect to a rotation of the second part 70 relative to the first part 15 about the Y-axis, wherein this stiffness is larger, the larger the distance of the first solid body joint 80A and of the second solid body joint 80B in the direction of the X-axis.

As can be seen from FIGS. 1 and 3, the rotary joint arrangement DGA can be formed in such a way that the second part 70 has a first elongate hollow space 71A, which, in the first direction Z, extends along the first plane ME1, wherein the first solid body joint 80A is arranged in the first elongate hollow space 71A in such a way that, in the first direction Z, the first solid body joint 80A extends through the first elongate hollow space 71A at least over a portion of its extension in the first direction Z.

The second part 70 can accordingly have a second elongate hollow space 71B, which, in the first direction Z, extends along the second plane ME2, wherein the second solid body joint 80B is arranged in the second elongate hollow space 71B in such a way that, in the first direction Z, the second solid body joint 80B extends through the second elongate hollow space 71B at least over a portion of its extension in the first direction Z.

In the present example, the first elongate hollow space 71A is dimensioned in such a way that at least the first end section E1 and the second end section E2 of the first solid body joint 80A extend over their entire extension h through the first elongate hollow space 71A in the first direction Z. The second elongate hollow space 71B is accordingly dimensioned so that the first end section E1 and the second end section E2 of the second solid body joint 80B extend over their entire extension h through the second elongate hollow space 71B in the first direction Z. In this case, the first solid body joint 80A is essentially completely embedded in the first elongate hollow space 71A, and the second solid body joint 80B is embedded completely in the second elongate hollow space 71B, so that this embodiment of the rotary joint arrangement DGA is formed to be particularly compact.

As FIGS. 2, 4A and 4C suggest, the extension hF of the respective central section F of the first solid body joint 80A and second solid body joint 80B in the first direction is larger than the extension h of the first end section E1 and of the second end section E2 in the present example.

In this case, the central section F of the first solid body joint 80A and the central section F of the second solid body joint 80B can protrude from the first elongate hollow space 71A or the second elongate hollow space 71B, respectively, by a distance in the first direction Z on the side facing the first part 15. This is advantageous in order to be able to fasten the central section F of the first solid body joint 80A and the central section F of the second solid body joint 80B on a side of the first part 15 facing the second part 70 by means of fastening means, so that the respective central sections F of the first solid body joint 80A and of the second solid body joint 80B are rigidly connected to the first part 15.

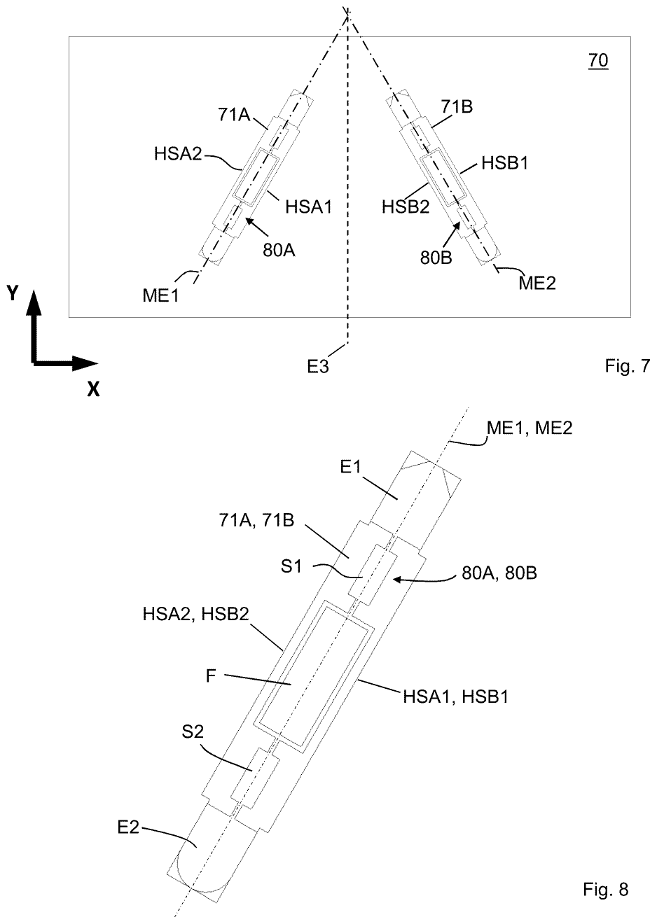

As can be seen from FIGS. 3, 7 and 8, the rotary joint arrangement DGA is formed in the present example in such a way that the first elongate hollow space 71A extends along the first plane ME1 in such a way that a longitudinal axis of the first elongate hollow space 71A is arranged parallel to the first plane ME1 and perpendicular to the first direction Z, and the elongate hollow space 71A is laterally limited with respect to the first plane ME1 by two side walls HSA1 or HSA2, respectively, of the second part 70, which are located opposite one another and which each extend in the first direction Z parallel to the first plane ME1 and have a distance relative to one another in a direction perpendicular to the first plane ME1.

The rotary joint arrangement DGA is accordingly formed in such a way that the second elongate hollow space 71B extends along the second plane ME2 in such a way that a longitudinal axis of the second elongate hollow space 71B is arranged parallel to the second plane ME2 and perpendicular to the first direction Z, and the second elongate hollow space 71B is laterally limited with respect to the second plane ME2 by two side walls HSB1 or HSB2, respectively, of the second part 70, which are located opposite one another and which each extend in the first direction Z parallel to the second plane ME2 and have a distance relative to one another in a direction perpendicular to the second plane ME2.

As can be seen from FIGS. 3, 7 and 8, the two side walls HSA1, HSA2 of the second part 70, which are located opposite one another and which laterally limit the first elongate hollow space 71A with respect to the first plane ME1, are formed in the present example in such a way that they enclose the first end section E1 and the second end section E2 of the first solid body joint 80A, so that the first end section E1 and the second end section E2 of the first solid body joint 80A are connected in a positive manner to the second part 70. It is ensured in this way that the first end section E1 and the second end section E2 of the first solid body joint 80A are rigidly held on the second part 70.

The two side walls HSB1, HSB2 of the second part 70, which are located opposite one another and which laterally limit the second elongate hollow space 71B with respect to the second plane ME2, can accordingly be formed in such a way that they enclose the first end section E1 and the second end section E2 of the second solid body joint 80B, so that the first end section E1 and the second end section E2 of the second solid body joint 80B are connected in a positive manner to the second part 70. It is ensured in this way that the first end section E1 and the second end section E2 of the second solid body joint 80B are rigidly held on the second part 70.

The first end section E1 and the second end section E2 of the first solid body joint 80A and of the second solid body joint 80B can be fastened to the second part 70 (by means of conventional fastening means, which are suitable for a connection of this type, e.g. by means of screws and/or by means of adhesion).

As can be seen from FIGS. 3, 7 and 8, the two side walls HSA1, HSA2, which are located opposite one another and which laterally limit the first elongate hollow space 71A with respect to the first plane ME1, are formed in such a way in the present example that they enclose the central section F of the first solid body joint 80A, wherein the two side walls HSA1, HSA2 of the second part 70 have a distance perpendicular to the first plane ME1, which is larger than an extension t_4 of the central section F of the first solid body joint 80A perpendicular to the first plane ME1. It is ensured in this way that the central section F of the first solid body joint 80A can be moved relative to the second part 70 when the first part 15 is to be moved relative to the second part 70.

The two side walls HSB1, HSB2, which are located opposite one another and which laterally limit the second elongate hollow space 71B with respect to the second plane ME2, are accordingly formed in such a way that they enclose the central section F of the second solid body joint 80B, wherein the two side walls HSB1, HSB2 of the second part 70 have a distance perpendicular to the second plane ME2, which is larger than an extension t_4 of the central section F of the second solid body joint 80B perpendicular to the second plane ME2. It is ensured in this way that the central section F of the second solid body joint 80B can be moved relative to the second part 70 when the first part 15 is to be moved relative to the second part 70.

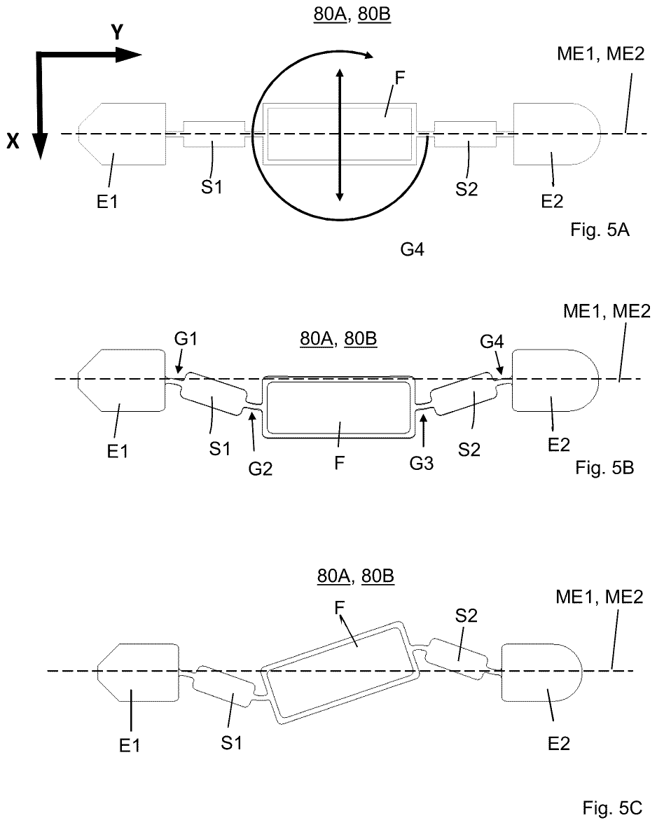

As FIGS. 3, 5A-5C, 7 and 8 suggest, the first solid body joint 80A and the second solid body joint 80B of the rotary joint arrangement DGA are arranged in such a way in the present example that:
the central section F of the first solid body joint 80A can be moved relative to the second part 70 in a translatory movement perpendicular to the first plane ME1 (FIG. 5B);
the central section F of the first solid body joint 80A can be moved relative to the second part 70 by means of a rotation about an axis of rotation extending in the first direction Z (FIG. 5C);
the central section F of the second solid body joint 80B can be moved relative to the second part 70 in a translatory movement perpendicular to the second plane ME2 (FIG. 5B);
the central section F of the second solid body joint 80B can be moved relative to the second part 70 by means of a rotation about an axis of rotation extending in the first direction Z (FIG. 5C)

The rotary joint arrangement DGA can be formed in such a way that the first plane ME1 and the second plane ME2 are inclined relative to one another in such a way that the first plane ME1 and the second plane ME2 intersect in the common intersection line DZ at an angle a (hereinafter “arrangement angle α”), which is larger than or equal to 10° and smaller than or equal to 120°. The rotary joint arrangement DGA can in particular be formed in such a way that the first plane ME1 and the second plane ME2 are inclined relative to one another in such a way that the first plane ME1 and the second plane ME2 intersect in the common intersection line DZ at an angle, which is larger than or equal to 30° and smaller than or equal to 90°.

The respective size of the arrangement angle a is relevant for the size of the stiffnesses and the size of natural frequencies of the coupled system formed from the first part 15, the second part 70, the first solid body joint 80A and the second solid body joint 80B.

One aspect of the invention relates to the design of the solid body joint 80A or 80B, respectively, which is rigidly connected to the second part 70 on both sides on the two end sections E1 and E2, with the middle piece F, which can be moved relative to the two end sections E1 and E2 and which is rigidly connected to the first part 15, for coupling the second part 70 of the rotary joint arrangement DGA to the first part 15 of the rotary joint arrangement DGA, which first part 15 is arranged relative to the second part so as to be offset axially to the axis of rotation DZ (stacked design). With the help of the design of the individual solid body joint 80A, 80B and of the arrangement angle 60 , the desired system natural frequencies and static stiffnesses can be set. The arrangement of two compact solid body joints 80A, 80B to form a functioning unit in the form of the coupling means KE is space-saving and can thus be integrated better into the rotary joint arrangement DGA.

In the case of the coupling means KE of the rotary joint arrangement DGA, the elastically deformable web parts S1 and S2 are responsible for the translatory and rotatory degrees of freedom. The two main degrees of freedom of the central section F of the solid body joint 80A or 80B, respectively, illustrated in FIGS. 4A-4C and 5A-5C are the translation in the X-direction and the rotation about the Z-axis with respect to the coordinate system illustrated in FIGS. 4A-4C and 5A-5C with the three axes X, Y, Z (X-axis, Y-axis, Z-axis) (which are orthogonal relative to one another). The X-axis is thereby oriented perpendicular to the first plane ME1 (with respect to the first solid body joint 80A) or perpendicular to the second plane ME2 (with respect to the second solid body joint 80B), respectively.

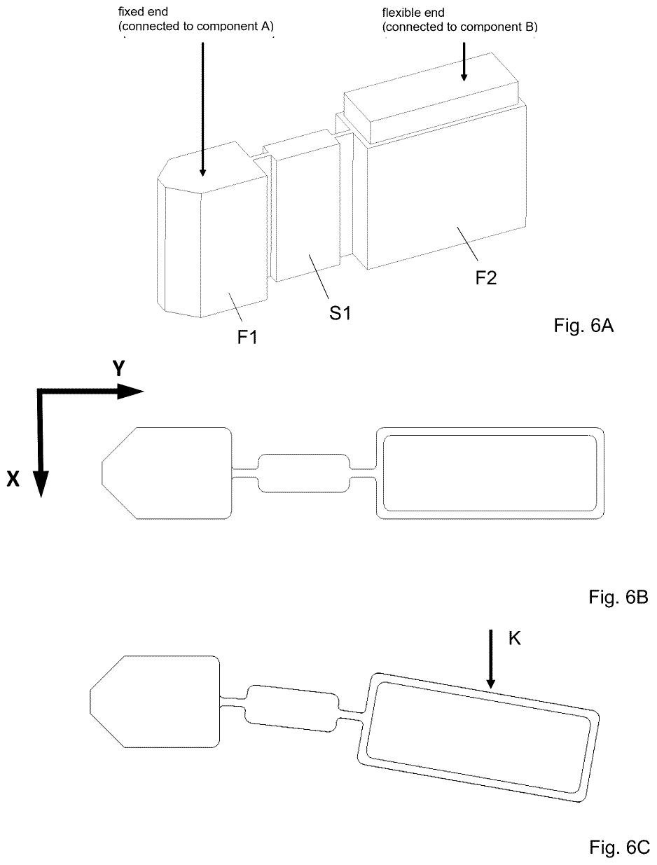

The two main degrees of freedom are characterized by correspondingly low natural frequencies and static stiffnesses. The rotation about the Y-axis (torsion) is to be named as tertiary degree of freedom of the central section F, which is influenced significantly by the length and thickness of the web parts S1 and S2. Due to the fact that the two end sections E1 and E2 of the respective solid body joint 80A or 80B, respectively, are rigidly connected to the second part 70 on both sides, deflections of the central section F occur in connection with deformations of the web parts S1 and S2, which deformations each correspond to a combination of tension and bending (for a translation of the central section F in the direction of the X-axis and a rotation of the central section F about an axis extending parallel to the Z direction, as illustrated in FIGS. 5A, 5B and 5C). This results in a significantly higher stiffness in all six degrees of freedom, compared with a conventional joint, which is illustrated in FIG. 6A-6C.

FIG. 6A-6C shows a conventional solid body joint, which has a fixed end F1 connected to a first component A, and a flexible end F2 connected to a second component B, which is connected to the fixed end F1 via an elastically deformable web part S1. In response to a mechanical stress of the flexible end F2 by means of a force K, a movement of the flexible end F2 relative to the fixed end F1 generally takes place in such a way that the web part S1 is deformed by means of a bending but is not under tension thereby. This results in a smaller stiffness of the conventional solid body joint compared with the coupling means KE of the rotary joint arrangement DGA according to the invention.

The above-described rigid connection of the two end sections E1 and E2 of the two solid body joints 80A and 80B with the second part 70 and the arrangement of the two solid body joints 80A and 80B relative to one another with the above-described arrangement angle a provides for a stiff connection between the end sections E1 and E2 of the two solid body joints 80A and 80B, whereby a combined solid body joint with a virtual axis of rotation DZ is formed. The rotational degree of freedom about the virtual axis of rotation DZ is created by a combination of the two degrees of freedom of a translation of the central section F in the X-direction according to FIG. 5B and a rotation of the central section F about an axis according to FIG. 5C, which extends parallel to the Z-direction, for each of the two solid body joints 80A and 80B.

To attain that the rotary joint arrangement DGA has a highest possible stiffness with respect to a rotation of the first part 15 relative to the second part 70 about the Y-axis according to FIG. 1-3, it is useful to place the two solid body joints 80A and 80B at a largest possible distance from one another (in the X-direction according to FIG. 1-3). The stiffness with respect to a rotation of the first part 15 relative to the second part 70 about the X-axis can be influenced via the design of the two solid body joints 80A, 80b and by the arrangement angle a. The combination of two solid body joints 80A and 80B, which are arranged at an angle a and which are each firmly connected to the second part 70 on both ends, provide for only relatively small rotations about the Z-axis due to the high stiffness of the two solid body joints 80A, 80B. In order to protect the solid body joints 80A & 80B against overload or in order to limit the movement of the central piece F, respectively, corresponding stops (corresponding to the side walls HSA1, HSA2, HSB1, HSB2) can be integrated into the second part 70.

In the present example, the rotational stiffness about the first direction (Z-axis) between the second part 70 and the first part 15 is to be kept as low as possible, while the stiffness in the Y-direction is to be as high as possible. An arrangement angle α of approximately 60° offers a good compromise for the present application. A parallel alignment (α=0°) of the two solid body joints 80A, 80B leads to a massive stiffening of the rotational stiffness about the Z-axis between the second part 70 and the first part 15, while the stiffness in the X-direction is reduced to a minimum. On the other hand, the arrangement with an arrangement angle α=180° leads to a stiffening of the system in the X-direction and to a massive reduction the stiffness in the Y-direction and of the stiffness with respect to the rotation of the first part 15 relative to the second part 70 about the X-axis and Z-axis.

With respect to the stiffnesses and the natural frequencies of the individual solid body joints 80A and 80B, the following determinations apply with regard to FIGS. 4A-4C and 5A-5C:
The individual solid body joint 80A and 80B is essentially symmetrical with respect to the two central planes XZ and YZ (FIG. 4B), wherein the end sections E1 and E2 as well as the central section F can vary in shape.
The individual solid body joint 80A and 80B is to have a low static stiffness and natural frequency with respect to a translation in the X-direction and a rotation about an axis extending parallel to the Z-direction, while the stiffnesses and natural frequencies for translations in the Y-direction and in the Z-direction and rotations about the X-direction and about the Y-direction are to remain as high as possible.
The stiffness and natural frequency with respect to a translation in the X-direction and a rotation about an axis extending parallel to the Z-direction is influenced significantly via the web part thickness t_1 and the distance l_2 between one of the two end sections E1 and E2 and the central section F. The larger the distance l_2, the smaller the stiffness and natural frequency with respect to a translation in the X-direction and a rotation about an axis extending parallel to the Z-direction. l_2 is thereby generally smaller than the height h. The smaller the web thickness t_1, the smaller the stiffness and natural frequency in all axial directions.
The stiffness and natural frequency with respect to a rotation about the Y-axis can be influenced via the web thickness t_1 and t_2 as well as the distance l_2, where: The larger the web thicknesses t_1 and t_2, the larger the stiffness and natural frequency with respect to a rotation about the Y-axis. The smaller the distance l_2, the larger the stiffness and natural frequency with respect to a rotation about the Y-axis.
With a local thickening of the web parts S1 and S2 to t_2, the torsional stiffness and natural frequency with respect to a rotation about the Y-axis is increased many times over (>factor of 3) and the risk of instability in the Y-direction due to bulging or bending is reduced. An increase of the stiffness (˜+50%) and natural frequency (˜+15%) also results for the remaining axial directions.
The stiffness and natural frequency with respect to a translation in the Z-direction and a rotation about an axis extending parallel to the X-direction is influenced by the web thickness t_1 and the height h. The larger the height h, the higher the stiffness and natural frequency with respect to a translation in the Z-direction and a rotation about an axis extending parallel to the X-direction. The web thickness t_1, web thickness t_2, thickness t_3, the height h and the lengths l_1 and l_2 can preferably be selected as follows:
   The ratio of web thickness t_1 to height h can preferably be in the range of 1:10 to 1:30;
   the ratio of web thickness t_1 to web thickness t_2 can preferably be in the range of 1:2 to 1:5;
   the ratio of web thickness t_1 to thickness t_3 can preferably be in the range of 1:5 to 1:30;
   the ratio of web thickness t_1 to web length l_1 can preferably be in the range of 1:2 to 1:5;
   the ratio of web length l_1 to web length l_2 can preferably be smaller than 1.

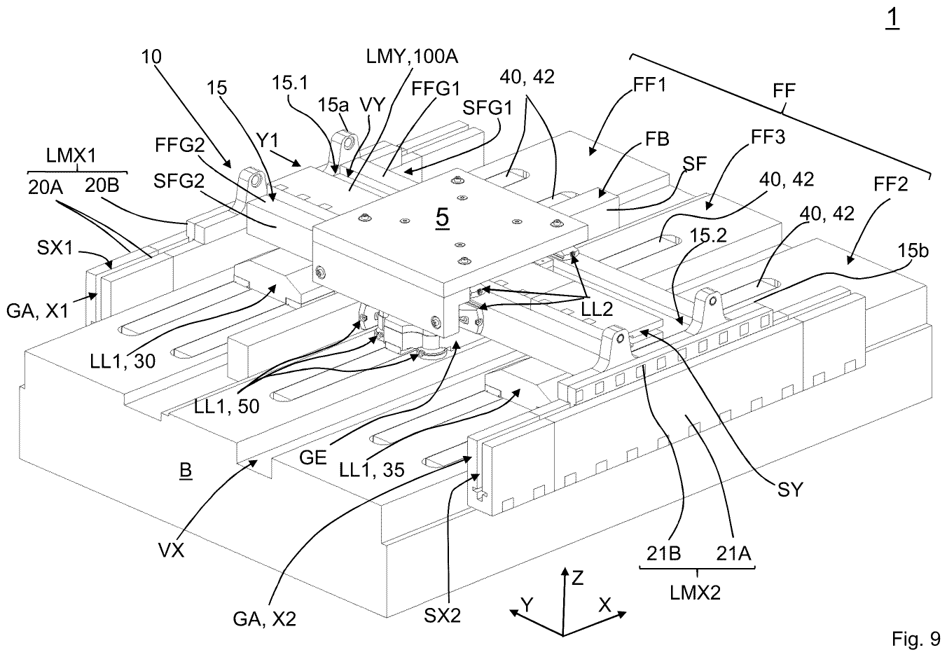

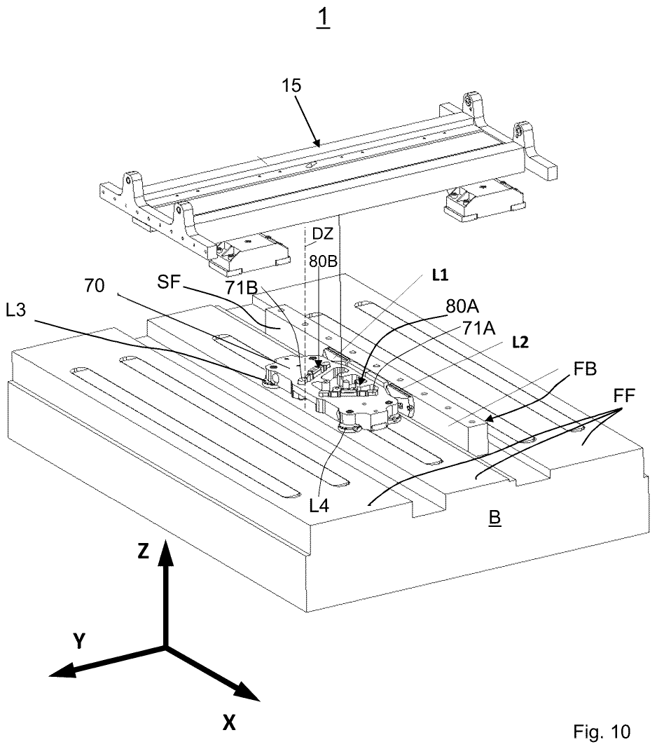

With respect to FIGS. 9 and 10, a positioning device in combination with a rotary joint arrangement DGA according to the invention will be described below.

FIGS. 9 and 10 show a positioning device 1 (or parts of this positioning device 1 respectively) for positioning a movable element 5. In the present example, the movable element 5 is designed as a movable platform or a movable table, respectively, comprising a bearing surface, onto which, for example, an object can be placed, which is to be positioned together with the movable element 5 by means of the positioning device 1.

FIGS. 9 and 10 show the positioning device 1 in a perspective view with respect to a coordinate system illustrated in FIGS. 9 and 10 with the three axes X, Y, Z (X-axis, Y-axis, Z-axis).

As can be seen from FIG. 10, the positioning device 1 comprises a base B, which can be realized, for example, as a plate made of granite and which, in the present example, has, on an upper side, a flat guide surface FF, which is arranged parallel to a second direction (corresponding to the direction of the X-axis according to FIG. 10, hereinafter “second direction X”) and parallel to a third direction (corresponding to the direction of the Y-axis according to FIG. 1, hereinafter “third direction Y”).

The positioning device 1 is designed to move the movable element 5 parallel to the flat guide surface FF of the base B in the second direction X and/or in the third direction Y, and to thereby position it in specified positions, in each case with an accuracy in the sub-micrometer range (i.e. less than 1 μm). In order to provide for a quick positioning, it is provided to be able to move the movable element 5 with a relatively large acceleration (2 g and more) in the second direction X and/or in the third direction Y.

For this purpose, the positioning device 1 has a first movement means 10 in Gantry design, which first movement means 10 comprises a Gantry beam 15 arranged above the flat guide surface FF and extending in the third direction Y at a distance from the flat guide surface FF, and a Gantry drive GA for moving the Gantry beam 15 relative to the base B in the second direction X. The Gantry beam 15 has a longitudinal axis extending in the third direction Y and, with respect to this longitudinal axis, has a first end 15.1 and a second end 15.2 located opposite the first end 15.1, wherein the Gantry drive GA comprises two first linear axes X1 or X2, respectively, extending in the second direction X, each comprising a linear drive LMX1 or LMX2, respectively. The linear drive LMX1 of the one first linear axis X1 is thereby connected to the first end 15.1 of the Gantry beam 15, so that the first end 15.1 of the Gantry beam 15 can be moved in the second direction X by means of the linear drive LMX1. The linear drive LMX2 of the other first linear axis X2 is therefore connected to the second end 15.2 of the Gantry beam 15, so that the second end 15.2 of the Gantry beam 15 can likewise be moved in the second direction X by means of the linear drive LMX2.

In the present example, the linear drives LMX1 and LMX2 are each formed as conventional linear motors. The linear drive LMX1 (which is formed as linear motor) therefore has a stator 20A, which extends linearly in the second direction X and which is fastened to the base B, and a rotor 20B, which is movable relative to the stator 20A in the second direction X and which is fastened to the first end 15.1 of the Gantry beam 15 via an adapter plate 15a. The linear drive LMX2 (which is formed as linear motor) therefore has a stator 21A, which extends linearly in the second direction X and which is fastened to the base B, and a rotor 21B, which is movable relative to the stator 21A in the second direction X and which is fastened to the second end 15.2 of the Gantry beam 15 via an adapter plate 15b.

In a cross section perpendicular to the second direction X, the stator 20A of the linear drive LMX1 as well as the stator 21A of the linear drive LMX2 each have an essentially U-shaped profile comprising two legs arranged next to one another, which each limit a gap extending in the second direction X over the entire length of the respective stator 20A or 20B, respectively, i.e. a gap SX1 in the case of the stator 20A and a gap SX2 in the case of the stator 21A. As is common in the case of conventional linear motors, the stator 20A comprises means for providing a static magnetic field in the gap SX1 of the stator 20A, and the stator 21A comprises means for providing a static magnetic field in the gap SX2 of the stator 21A. The rotor 20B of the linear drive LMX1 therefore comprises a coil (not illustrated in the figures), which can be supplied with an alternating electric current for generating an alternating magnetic field, and extends spatially in such a way that a section 20B-1 of the rotor 20B, which comprises the coil of the rotor 20B, protrudes into the gap SX1 of the stator 20A, and the rotor 20B can be moved in the second direction X in this gap SX1 over a distance, which corresponds to the extension of the stator 20A in the second direction X. The rotor 21B of the linear drive LMX2 therefore comprises a coil (not illustrated in the figures), which can be supplied with an alternating electric current for generating an alternating magnetic field, and extends spatially in such a way that a section 21B-1 of the rotor 21B, which comprises the coil of the rotor 21B, protrudes into the gap SX2 of the stator 21A, and the rotor 21B can be moved in the second direction X in this gap SX2 over a distance, which corresponds to the extension of the stator 21A in the second direction X. In order to control a movement of the Gantry beam 15 in the second direction X, the linear drives LMX1 and LMX2 of the two first linear axes X1 or X2, respectively, can be controlled independently of one another by means of a control device (not illustrated in the figures).

In order to attain a space-saving arrangement of the two first linear axes X1 or X2, respectively, the stators of the linear drives LMX1 and LMX2 of the present embodiment of the positioning device 1 according to FIG. 1 are arranged in such a way that the gap SX1 of the stator 20A as well as the gap SX2 of the stator 21A and the rotor 20B as well as the rotor 21B extend essentially parallel to a plane, which is arranged parallel to the second direction X and perpendicular to the flat guide surface FF of the base B, so that the gap SX1 of the stator 20A as well as the gap SX2 of the stator 21A and the rotor 20B as well as the rotor 21B each have an essentially smaller extension in the third direction Y than in the direction perpendicular to the flat guide surface FF. This arrangement of the two first linear axes X1 or X2, respectively, is advantageous in view of a stressing of a smallest possible base surface in a plane, which extends parallel to the second direction X and parallel to the third direction Y, especially since due to the respective structures of the stators 20A and 21A and the structures of the rotors 20B and 21B in the above-mentioned arrangement perpendicular to the flat guide surface FF, each of the two linear drives LMX1 and LMX2 have an extension, which is several times greater (typically by more than a factor of 2) than the extension of the respective linear drive LMX1 or LMX2, respectively, in the third direction Y. The latter can be seen clearly in FIG. 10, in particular on the basis of the illustration of the positioning device 1. The above-mentioned arrangement of the two first linear axes X1 or X2, respectively, thus provides for a structure of the positioning device 1, which has a particularly small spatial extension in the direction of the third direction Y (according to the longitudinal direction of the Gantry beam 15), and which is minimized in particular in view of the arrangement of the two first linear axes X1 or X2, respectively.

As suggested in FIG. 9, the movable element 5 is mounted on the Gantry beam 15 in such a way that the movable element 5 is linearly movable in the third direction Y on the Gantry beam 15, wherein the Gantry beam 15 has a second linear axis Y1 extending in the third direction Y comprising a linear drive LMY connected to the movable element 5 for moving the movable element 5 in the third direction Y.

In the present example, the linear drive LMY of the second linear axis Y1 is likewise formed as conventional linear motor and comprises (analogously to the structure of the linear drives LMX1 and LMX2) a stator 100A, which extends linearly in the third direction Y and which is fastened to the upper side of the Gantry beam 15, and which extends in the third direction Y between the first end 15.1 and the second end 15.2 over the entire length of the Gantry beam 15, and a rotor 100B, which can be moved relative to the stator 100A in the third direction Y and which is fastened to the movable element 5.

In a cross section perpendicular to the third direction Y, the stator 100A of the linear drive LMY has an essentially U-shaped profile comprising two legs arranged next to one another, which each limit a gap SY extending in the third direction Y over the entire length of the stator 100A. The stator 100A comprises means for providing a static magnetic field in the gap SY of the stator 100A. The rotor 100B of the linear drive LMY therefore comprises a coil (not illustrated in the figures), which can be supplied with an alternating electric current for generating an alternating magnetic field, and spatially extends in such a way that a section 100B-1 of the rotor 100B comprising the coil of the rotor 100B protrudes into the gap SY of the stator 100A, and the rotor 100B can be moved in the third direction Y in this gap SY over a distance, which corresponds to the extension of the stator 100A in the third direction Y. In order to control a movement of the movable element 5 in the third direction Y, the linear drive LMY can be controlled by means of a control device (not illustrated in the figures).

As suggested in FIG. 9, the positioning device 1 comprises a first air bearing means LL1 comprising several air bearings connected to the Gantry beam 15 for guiding the Gantry beam on the flat guide surface FF of the base B. As can be seen from FIG. 9, the first air bearing means LL1 has a first air bearing arrangement 30, which comprises at least one first horizontal air bearing arranged on the first end 15.1 of the Gantry beam 15 for guiding the first end 15.1 of the Gantry beam 15 on a first section FF1 of the flat guide surface FF extending in the second direction X. The first air bearing means LL1 additionally has a second air bearing arrangement 35, which comprises at least one second horizontal air bearing arranged on the second end 15.2 of the Gantry beam 15 for guiding the second end 15.2 of the Gantry beam 15 on a second section FF2 of the flat guide surface FF extending in the second direction X. The respective air bearings of the first air bearing arrangement 30 and of the second air bearing arrangement 35 have the task of supporting or guiding, respectively, the Gantry beam 15 in each case on a section on the first end 15.1 of the Gantry beam 15 and on a section on the second end 15.2 of the Gantry beam 15 on the flat guide surface FF.

As additionally suggested in FIG. 9, the first air bearing means LL1 additionally has a third air bearing arrangement 50, which comprises at least one third horizontal air bearing and at least one fourth horizontal air bearing, wherein the at least one third horizontal air bearing and the at least one fourth horizontal air bearing are arranged on a “central section” of the Gantry beam 15 between the first end 15.1 of the Gantry beam 15 and the second end 15.2 of the Gantry beam 15, so that the “central section” of the Gantry beam 15 is guided on a third section FF3 of the flat guide surface FF by means of the third horizontal air bearing and of the fourth horizontal air bearing, which third section FF3 extends in the second direction X and which, with respect to the third direction Y, is arranged between the first section FF1 of the flat guide surface FF and the second section FF2 of the flat guide surface. Details of the third air bearing arrangement 50 with respect to the above-mentioned at least one third horizontal air bearing and the above-mentioned at least one fourth horizontal air bearing will be described below, in connection with FIG. 10.

In this context, “central section” of the Gantry beam 15 is to be considered to be a longitudinal section of the Gantry beam 15 extending in the third direction Y, which, in the third direction Y, extends over a length, which is maximally 50% of the extension of the Gantry beam 15 in the third direction Y, and which, with respect to the first end 15.1 of the Gantry beam 15 and of the second end 15.2 of the Gantry beam 15, in each case has a distance in the third direction Y, which is at least 25% of the extension of the Gantry beam 15 in the third direction Y.

As additionally illustrated in FIG. 9, a guide beam FB, which extends in the second direction X and which has a flat side surface SF, which extends parallel to the second direction X and parallel to a first direction directed essentially perpendicular to the flat guide surface FF (corresponding to the direction of the Z-axis according to FIG. 9, hereinafter “first direction Z”), is arranged on the base B next to the third section FF3 of the flat guide surface FF. The third air bearing arrangement 50 additionally comprises at least one lateral air bearing arranged on the central section of the Gantry beam 15 for guiding the Gantry beam on the one flat side surface SF of the guide beam FB. Details of the third air bearing arrangement 50 with respect to the above-mentioned at least one lateral air bearing will be described below in connection with FIG. 10.

As will be described in more detail below, all air bearings of the third air bearing arrangement 50 in the present example are part of an “assembly”, which forms a unit and which is fastened to the Gantry beam 15 and which is arranged below the Gantry beam 15 in an intermediate space between the Gantry beam 15 and the flat guide surface FF and which has the task of supporting or guiding, respectively, the Gantry beam 15 in the region of the central section of the Gantry beam 15 by means of the horizontal air bearings of the third air bearing arrangement 50 in the region of the third section FF3 of the flat guide surface FF, and the task of guiding the Gantry beam 15 laterally on the flat side surface SF of the guide beam FB during a movement in the second direction X by means of the at least one lateral air bearing of the third air bearing arrangement 50. The above-mentioned assembly therefore forms a “sliding element” GE, which is fastened to the Gantry beam 15 and which is formed to slide without contact on the third section FF3 of the flat guide surface FF and on the flat side surface SF of the guide beam FB in the second direction X during the operation of the positioning device 1, namely on air cushions, which can be created between the sliding element GE and the third section FF3 of the flat guide surface FF by means of the respective horizontal air bearings of the third air bearing arrangement 50, and on air cushions, which can be created between the sliding element GE and the flat side surface SF of the guide beam FB by means of the respective lateral air bearings of the third air bearing arrangement 50.

It is important to point out that each horizontal air bearing of the first air bearing means LL1 is preloaded with respect to the flat guide surface FF of the base B, and each lateral air bearing of the first air bearing means LL1 is preloaded with respect to the flat side surface SF of the guide beam FB. Each air bearing of the second air bearing means LL2 is therefore preloaded with respect to one of the flat guide surfaces FFG1 or FFG2, respectively, of the Gantry beam 15 or with respect to the flat side surface SFG2 of the Gantry beam 15. Magnetic means, which are not relevant with respect to the present invention and which will thus not be described in more detail, serve the purpose of preloading the respective air bearings in the present example.

With respect to FIGS. 9 and 10, details of the sliding element GE will be described below in connection with the air bearings of the third air bearing arrangement 50. As can be seen in particular from FIG. 10, the sliding element GE comprises a carrier 70 as essential component, which is intended to receive the air bearings of the third air bearing arrangement 50 and to be fastened to the Gantry beam 15, in order to hold the air bearings of the third air bearing arrangement 50 at specified positions with respect to the Gantry beam 15. In the present example, the carrier 70 is formed as a housing, which has several hollow spaces.

In the present example, the carrier 70 has the shape of a flat plate. As can be seen from FIGS. 9 and 10, the carrier 70 is mounted on the Gantry beam 15 in such a way that the carrier 70 extends below the Gantry beam 15 in an intermediate space between the Gantry beam 15 and the third section FF3 of the flat guide surface FF parallel to the flat guide surface FF of the base B and parallel to the flat side surface SF of the guide beam FB.

As can be seen from FIG. 10, the third air bearing arrangement 50 in the present example comprises a total of two horizontal air bearings L3 and L4, which are arranged on an underside of the carrier 70 facing the flat guide surface FF of the base B.

As can be seen from FIG. 10, the two horizontal air bearings L3 and L4 are arranged relative to one another in such a way that they have a distance in the second direction X relative to one another.

As can be seen from FIG. 10, the third air bearing arrangement 50 in the present example has two lateral air bearings L1 or L2, respectively, for guiding the Gantry beam 15 on the flat side surface SF of the guide beam FB, wherein the two lateral air bearings L1 and L2 are arranged relative to one another in such a way that they have a distance in the second direction X relative to one another.

As can be seen from FIG. 10, two elongate, essentially cuboidal hollow spaces 71A or 71B, respectively, are formed in the carrier 70 on a top side of the carrier 70 facing the Gantry beam 15, which elongate hollow spaces 71A, 71B each have a longitudinal axis extending perpendicular to the first direction Z or parallel to the flat guide surface FF of the base B, respectively, and which, with respect to the second direction X, are arranged in such a way that the elongate hollow space 71A and the elongate hollow space 71B have a distance relative to one another in the second direction X,. As suggested in FIG. 10, the elongate hollow spaces 71A and 71B serve the purpose of receiving a first solid body joint 80A or a second solid body joint 80B, respectively, wherein the first solid body joint 80A is intended to be inserted into the hollow space 71A, and the second solid body joint 80B is intended to be inserted into the hollow space 71B, and the two solid body joints 80A or 80B, respectively, are provided to establish a connection between the carrier 70 and the Gantry beam 15 in such a way that the sliding element GE, on the one hand, is held via the two solid body joints 80A or 80B, respectively, with respect to the Gantry beam 15 in a stable position, and, on the other hand, is mounted on the Gantry beam 15 via the two solid body joints 80A or 80B, respectively, in such a way that the sliding element GE can be rotated relative to the Gantry beam 15 about an axis of rotation extending in the first direction Z, so that the arrangement of the two solid body joints 80A or 80B, respectively, therefore represents a “rotary joint”, which serves the purpose of connecting the sliding element GE to the Gantry beam 15 and to hold it on the Gantry beam 15 in a movable (rotatable) manner.

In the present example, the positioning device 1 is designed in such a way that the Gantry beam 15, the carrier 70, the first solid body joint 80A and the seconds solid body joint 80B form an embodiment of the rotary joint arrangement according to the invention.

The Gantry beam 15, the carrier 70, the first solid body joint 80A and the second solid body joint 80B of the positioning device 1 correspond in particular structurally and functionally to the rotary joint arrangement DGA illustrated in FIG. 1-3: The Gantry beam 15 of the positioning device 1 thereby corresponds to the first part 15 of the rotary joint arrangement DGA, the carrier 70 of the positioning device 1 corresponds to the second part 70 of the rotary joint arrangement DGA, the first solid body joint 80A of the positioning device 1 is identical to the first solid body joint 80A of the rotary joint arrangement DGA and the seconds solid body joint 80B of the positioning device 1 is identical to the second solid body joint 80B of the rotary joint arrangement DGA.

The elongate hollow spaces 71A and 71B formed in the carrier 70 of the positioning device 1 for receiving the first solid body joint 80A or the second solid body joint 80B, respectively, correspond analogously to the elongate hollow spaces 71A and 71B formed in the second part 70 of the rotary joint arrangement DGA.

The above-described structure of the carrier 70 provides for an integration of the two solid body joints 80A or 80B, respectively, into the carrier 70. For this purpose, the solid body joint 80A as a whole can be inserted into the first elongate hollow space 71A so that the two end sections E1 and E2 of the first solid body joint 80A are rigidly connected to the carrier 70 (by means of conventional fastening means, which are suitable for a connection of this type, e.g. by means of screws and/or by means of adhesion), while the central section F of the first solid body joint 80A is rigidly connected to the Gantry beam 15.

For this purpose, the second solid body joint 80B can be inserted as a whole into the second elongate hollow space 71B so that the two end sections E1 and E2 of the second solid body joint 80B are rigidly connected to the carrier 70 (by means of conventional fastening means, which are suitable for a connection of this type, e.g. by means of screws and/or by means of adhesion), while the central section F of the second solid body joint 80B is rigidly connected to the Gantry beam 15.

As FIG. 10 suggests, the first solid body joint 80A as well as the second solid body joint 80B in each case consists of an elongate solid body (e.g. of steel), which extends perpendicular to the first direction Z along a plane parallel to the first direction Z and which has a longitudinal axis, which is arranged perpendicular to the first direction Z.

As suggested in FIGS. 1 and 10, it is assumed in this context that a first elongate solid body forming the first solid body joint 80A extends along a first plane ME1, which is parallel to the first direction Z, and that a second elongate solid body forming the second solid body joint 80B extends along a second plane ME2, which is parallel to the first direction Z.

The first solid body joint 80A and the second solid body joint 80B are formed to hold the carrier 70 or the sliding element GE, respectively, in a stable rest position with respect to the Gantry beam 15, when both solid body joints 80A and 80B are each in their undeformed base state (as illustrated in FIG. 9). Due to the fact that the first web part S1 and the second web part S2 of the first solid body joint 80A and the first web part S1 and the second web part S2 of the second solid body joint 80B are each formed to be elastically deformable, and due to the fact that the central section F of the first solid body joint 80A (in the undeformed base state of the first solid body joint 80A) in each case has a distance from the wall section HSA1 as well as from the wall section HSA2 in a direction perpendicular to the first plane ME1, and the central section F of the second solid body joint 80B (in the undeformed base state of the second solid body joint 80B) additionally in each case has a distance from the wall section HSB1 as well as from the wall section HSB2 in a direction perpendicular to the second plane ME2, the carrier 70 or the sliding element GE, respectively, is held on the Gantry beam 15 by means of the first solid body joint 80A and the second solid body joint 80B in such a way that the carrier 70 or the sliding element GE, respectively, is movable relative to the Gantry beam 15, provided that the central section F of the first solid body joint 80A does not abut against one of the wall sections HSA1 or HSA2, respectively, and one of the wall sections HSA1 or HSA2, respectively, does not block a corresponding movement of the carrier 70 or of the sliding element GE, respectively, relative to the Gantry beam 15 and/or provided that the central section F of the second solid body joint 80B does not abut against one of the wall sections HSB1 or HSB2, respectively, and one of the wall sections HSB1 or HSB2, respectively, does not block a corresponding movement of the carrier 70 or of the sliding element GE, respectively, relative to the Gantry beam 15.

In the case of the positioning device 1, it is of interest that the arrangement of the first solid body joint 80A and of the second solid body joint 80B represents a connection between the carrier 70 or the sliding element GE, respectively, and the Gantry beam 15, which, on the one hand, ensures a highest possible stiffness with regard to a translation of the carrier 70 or of the sliding element GE, respectively, relative to the Gantry beam 15 in the second direction X and in the third direction Y and in the first direction Z, but, on the other hand, has a smallest possible stiffness with regard to a rotation of the carrier 70 or of the sliding element GE, respectively, relative to the Gantry beam 15 about an axis of rotation extending in the first direction Z.

In order to fulfill the above-mentioned requirements, the first solid body joint 80A and the second solid body joint 80B are arranged relative to one another on the carrier 70 in such a way that the first plane ME1 and the second plane ME2 are not arranged parallel to one another but are inclined relative to one another in such a way that the first plane ME1 and the second plane ME2 form a common intersection line DZ, which extends parallel to the first direction Z (as illustrated in FIG. 1). In this case, the first plane ME1 and the second plane ME2 form an angle a, which has to be greater than 0° and smaller than 180°, with respect to the common intersection line DZ. In order to ensure a sufficiently high stiffness of the arrangement of the first solid body joint 80A and of the second solid body joint 80B with respect to a translation of the carrier 70 or of the sliding element GE, respectively, relative to the Gantry beam 15 in the second direction X and in the third direction Y, the angle α should preferably fulfill the condition 30°≤α≤90°. In the case of the example illustrated in FIGS. 9 and 10, the angle α is approx. 60°.

An arrangement of the first solid body joint 80A and of the second solid body joint 80B in such a way that the first plane ME1 and the second plane ME2 form an angle α of approx. 60° with respect to the common intersection line DZ, represents a good compromise in the present case in such a way that the stiffness of the arrangement of the first solid body joint 80A and of the second solid body joint 80B with respect to a rotation of the carrier 70 or of the sliding element GE, respectively, relative to the Gantry beam 15 about the common intersection line DZ of the first plane ME1 and of the second plane ME2 is sufficiently small, and the stiffness of the arrangement of the first solid body joint 80A and of the second solid body joint 80B with respect to a translation of the carrier 70 or of the sliding element GE, respectively, relative to the Gantry beam 15 in the second direction X and in the third direction Y is sufficiently high.

In this context, the common intersection line DZ of the first plane ME1 and of the second plane ME2 form a “virtual” axis of rotation (which extends in the first direction Z), about which the carrier 70 or the sliding element GE, respectively, is rotatably mounted relative to the Gantry beam 15 by means of the arrangement of the first solid body joint 80A and of the second solid body joint 80B.

By means of a suitable selection of the arrangement of the wall sections HSA1 and/or HSA2 and/or HSB1 and/or HSB2, a maximum angle of rotation can therefore be specified, about which the carrier 70 can be rotated from its rest position about the “virtual” axis of rotation DZ. The first solid body joint 80A and the second solid body joint 80B can be protected against a mechanical overload in this way. In the case of the positioning device 1, it can be expedient, for example, that the carrier 70 can be rotated relative to the Gantry beam 15 about a “virtual” axis of rotation DZ at least about an angle of ±0.1°.

1. A rotary joint arrangement (DGA), comprising
a first part (15),
a second part (70), and
a coupling means (KE) comprising at least one solid body joint (80A, 80B) for connecting the first part (15) and the second part (70) in such a way that the second part is enabled to be rotated relative to the first part about an axis of rotation (DZ) extending in a first direction (Z),
wherein the first part (15) and the second part (70) each have an extension perpendicular to the axis of rotation (DZ),
wherein the second part is arranged relative to the first part so as to be offset by a distance axially to the axis of rotation (DZ),
wherein
the coupling means (KE) has a first solid body joint (80A) and a second solid body joint (80B),
wherein the first solid body joint (80A) comprises a first elongate solid body, which extends perpendicular to the first direction (Z) along a first plane (ME1) parallel to the first direction (Z), and which has a longitudinal axis arranged perpendicular to the first direction (Z), wherein the first elongate solid body has the following longitudinal sections, which are arranged one behind another in the direction of the longitudinal axis of the first elongate solid body:
a first end section (E1), which forms a first end of the first elongate solid body;
a second end section (E2), which forms a second end of the first elongate solid body located opposite the first end of the first elongate solid body in the direction of the longitudinal axis of the first elongate solid body;
a central section (F) arranged between the first end section and the second end section of the first elongate solid body;
a first web part (S1) arranged between the first end section (E1) and the central section (F) of the first elongate solid body, connected to the first end section (E1) and the central section (F);
a second web part (S2) arranged between the second end section (E2) and the central section (F) of the first elongate solid body, connected to the second end section (E2) and the central section (F) of the first elongate solid body;
wherein the second solid body joint (80B) comprises a second elongate solid body, which extends perpendicular to the first direction (Z) along a second plane (ME2) parallel to the first direction (Z), and which has a longitudinal axis arranged perpendicular to the first direction (Z), wherein the second elongate solid body has the following longitudinal sections, which are arranged one behind another, in the direction of the longitudinal axis of the second elongate solid body:
a first end section (E1), which forms a first end of the second elongate solid body;
a second end section (E2), which forms a second end of the second elongate solid body located opposite the first end of the second elongate solid body in the direction of the longitudinal axis of the second elongate solid body;
a central section (F) arranged between the first end section and the second end section of the second elongate solid body;
a first web part (S1) arranged between the first end section (E1) and the central section (F) of the second elongate solid body, connected to the first end section and the central section;
a second web part (S2) arranged between the second end section (E2) and the central section (F) of the second elongate solid body, connected to the second end section (E2) and the central section (F) of the second elongate solid body;
wherein the first part (15) is connected to the second part (70) via the first solid body joint (80A) and the second solid body joint (80B) in such a way
that the first end section (E1) of the first elongate solid body and the second end section (E2) of the first elongate solid body are rigidly connected to the second part

(70) and the central section (F) of the first elongate solid body is rigidly connected to the first part (15) and
that the first end section (E1) of the second elongate solid body and the second end section (E2) of the second elongate solid body are rigidly connected to the second part (70), and the central section (F) of the second elongate solid body is rigidly connected to the first part (15),
wherein the first plane (ME1) and the second plane (ME2) are inclined relative to one another in such a way that the first plane (ME1) and the second plane (ME2) form a common intersection line (DZ), which extends parallel to the first direction (Z),
wherein the first web part (S1) and the second web part (S2) of the first elongate solid body of the first solid body joint (80A) each have an extension (t_1, t_2) perpendicular to the first plane (ME1), which is smaller than an extension (t_3) of the first end section (E1) of the first elongate solid body perpendicular to the first plane (ME1), an extension (t_3) of the second end section (E2) of the first elongate solid body perpendicular to the first plane (ME1) and an extension (t_4) of the central section (F) of the first elongate solid body perpendicular to the first plane (ME1), so that the first web part (S1) and the second web part (S2) of the first elongate solid body are elastically deformable, and the central section (F) of the first solid body joint (80A) is enabled to be moved relative to the first end section (E1) of the first solid body joint (80A) and to the second end section (E2) of the first solid body joint (80A);
wherein the first web part (S1) and the second web part (S2) of the second elongate solid body of the second solid body joint (80B) each have an extension (t_1, t_2) perpendicular to the second plane (ME2), which is smaller than an extension (t_3) of the first end section (E1) of the second elongate solid body perpendicular to the second plane (ME2), an extension (t_3) of the second end section (E2) of the second elongate solid body perpendicular to the second plane (ME2) and an extension (t_4) of the central section (F) of the second elongate solid body perpendicular to the second plane (ME2), so that the first web part (S1) and the second web part (S2) of the second elongate solid body are elastically deformable, and the central section (F) of the second solid body joint (80B) is enabled to be moved relative to the first end section (E1) of the second solid body joint (80B) and to the second end section (E2) of the second solid body joint (80B);
wherein the second part (70) is rotatably mounted on the first part (15) about the common intersection line (DZ) of the first plane (ME1) and of the second plane (ME2) by means of the first solid body joint (80A) and the second solid body joint (80B).

2. The rotary joint arrangement (DGA) according to claim 1, wherein
in an undeformed state of the first solid body joint (80A), the first solid body joint (80A) is formed symmetrically to the first plane (ME1), and/or
in an undeformed state of the second solid body joint (80B), the second solid body joint (80B) is formed symmetrically to the second plane (ME2).

3. The rotary joint arrangement (DGA) according to claim 1, wherein
in the first direction (Z), the first end section (E1) of the first elongate solid body of the first solid body joint (80A) has an extension (h), which is larger than the extension (t_3) of the first end section (E1) of the first elongate solid body perpendicular to the first plane (ME1); and/or
in the first direction (Z), the second end section (E2) of the first elongate solid body of the first solid body joint (80A) has an extension (h), which is larger than the extension (t_3) of the second end section (E2) of the first elongate solid body perpendicular to the first plane (ME1); and/or
in the first direction (Z), the central section (F) of the first elongate solid body of the first solid body joint (80A) has an extension (hF), which is larger than the extension (t_4) of the central section (F) of the first elongate solid body perpendicular to the first plane (ME1); and/or
in the first direction (Z), the first web part (S1) of the first elongate solid body of the first solid body joint (80A) has an extension (h), which is larger than the extension (t_2) of the first web part (S1) of the first elongate solid body perpendicular to the first plane (ME1); and/or
in the first direction (Z), the second web part (S2) of the first elongate solid body of the first solid body joint (80A) has an extension (h), which is larger than the extension (t_2) of the second web part (S2) of the first elongate solid body perpendicular to the first plane (ME1); and/or
in the first direction (Z), the first end section (E1) of the second elongate solid body of the second solid body joint (80B) has an extension (h), which is larger than the extension (t_3) of the first end section (E1) of the second elongate solid body perpendicular to the second plane (ME2); and/or
in the first direction (Z), the second end section (E2) of the second elongate solid body of the second solid body joint (80B) has an extension (h), which is larger than the extension (t_3) of the second end section (E2) of the second elongate solid body perpendicular to the second plane (ME2); and/or
in the first direction (Z), the central section (F) of the second elongate solid body of the second solid body joint (80B) has an extension (hF), which is larger than the extension (t_4) of the central section (F) of the second elongate solid body perpendicular to the second plane (ME2); and/or
in the first direction (Z), the first web part (S1) of the second elongate solid body of the second solid body joint (80B) has an extension (h), which is larger than the extension (t_2) of the first web part (S1) of the second elongate solid body perpendicular to the second plane (ME2); and/or
in the first direction (Z), the second web part (S2) of the second elongate solid body of the second solid body joint (80B) has an extension (h), which is larger than the extension (t_2) of the second web part (S2) of the second elongate solid body perpendicular to the second plane (ME2).

4. The rotary joint arrangement (DGA) according to claim 1,
wherein
in an undeformed state of the first solid body joint (80A), the first solid body joint (80A), and, in an undeformed state of the second solid body joint (80B), the second solid body joint (80B) are arranged relative to one another in such a way that the first solid body joint (80A) and the second solid body joint (80B) are arranged symmetrically with respect to a third plane (E3), which extends parallel to the first direction (Z), wherein the common intersection line (DZ) of the first plane (ME1) and of the second plane (ME2) extends in the third plane (E3).

5. The rotary joint arrangement (DGA) according to claim 1,
wherein
the first solid body joint (80A) is arranged relative to the second solid body joint (80B) in such a way that the first solid body joint (80A) has a distance from the second solid body joint (80B) perpendicular to the first direction (Z).

6. The rotary joint arrangement (DGA) according to claim 1,
wherein the second part (70) has a first elongate hollow space (71A), which, in the first direction (Z), extends along the first plane (ME1), and the first solid body joint (80A) is arranged in the first elongate hollow space (71A) in such a way that, in the first direction (Z), the first solid body joint (80A) extends through the first elongate hollow space (71A) in the first direction (Z) at least over a portion of its extension;
wherein the second part (70) has a second elongate hollow space (71B), which, in the first direction (Z), extends along the second plane (ME2), and the second solid body joint (80B) is arranged in the second elongate hollow space (71B) in such a way that, in the first direction (Z), the second solid body joint (80B) extends through the second elongate hollow space (71B) in the first direction (Z) at least over a portion of its extension.

7. The rotary joint arrangement (DGA) according to claim 6,
wherein the first elongate hollow space (71A) extends along the first plane (ME1) in such a way that a longitudinal axis of the first elongate hollow space (71A) is arranged parallel to the first plane (ME1) and perpendicular to the first direction (Z), and the first elongate hollow space (71A) is limited laterally with respect to the first plane (ME1) by means of two side walls (HSA1, HSA2) of the second part (70), which are located opposite one another and which each extend in the first direction (Z) parallel to the first plane (ME1) and have a distance relative to one another in a direction perpendicular to the first plane (ME1);
wherein the second elongate hollow space (71B) extends along the second plane (ME2) in such a way that a longitudinal axis of the second elongate hollow space (71B) is arranged parallel to the second plane (ME2) and perpendicular to the first direction (Z), and the second elongate hollow space (71B) is limited laterally with respect to the second plane (ME2) by two side walls (HSB1, HSB2) of the second part (70), which are located opposite one another and which each extend in the first direction (Z) parallel to the second plane (ME2) and which have a distance relative to one another in a direction perpendicular to the second plane (ME2).

8. The rotary joint arrangement (DGA) according to claim 6,
wherein the two side walls (HSA1, HSA2) of the second part (70), which are located opposite one another and which laterally limit the first elongate hollow space (71A) with respect to the first plane (ME1), are formed in such a way that they enclose the first end section (E1) and the second end section (E2) of the first solid body joint (80A), so that the first end section (E1) and the second end section (E2) of the first solid body joint (80A) are connected in a positive manner to the second part (70);
wherein the two side walls (HSB1, HSB2) of the second part (70), which are located opposite one another and which laterally limit the second elongate hollow space (71B) with respect to the second plane (ME2), are formed in such a way that they enclose the first end section (E1) and the second end section (E2) of the second solid body joint (80B), so that the first end section (E1) and the second end section (E2) of the second solid body joint (80B) are connected in a positive manner to the second part (70).

9. The rotary joint arrangement (DGA) according to claim 6,
wherein the two side walls (HSA1, HSA2) of the second part (70), which are located opposite one another and which laterally limit the first elongate hollow space (71A) with respect to the first plane (ME1), are formed in such a way that they enclose the central section (F) of the first solid body joint (80A), wherein, perpendicular to the first plane (ME1), the two side walls (HSA1, HSA2) of the second part (70), which are located opposite one another and which laterally limit the first elongate hollow space (71A) with respect to the first plane (ME1), have a distance perpendicular to the first plane (ME1), which is larger than an extension (t_4) of the central section (F) of the first solid body joint (80A) perpendicular to the first plane (ME1), so that the central section (F) of the first solid body joint (80A) is enabled to be moved relative to the second part (70);
wherein the two side walls (HSB1, HSB2) of the second part (70), which are located opposite one another and which laterally limit the second elongate hollow space (71B) with respect to the second plane (ME2), are formed in such a way that they enclose the central section (F) of the second solid body joint (80B), wherein, perpendicular to the second plane (ME2), the two side walls (HSB1, HSB2) of the second part (70), which are located opposite one another and which laterally limit the second elongate hollow space (71B) with respect to the second plane (ME2), have a distance, which is larger than an extension (t_4) of the central section (F) of the second solid body joint (80B) perpendicular to the second plane (ME2), so that the central section (F) of the second solid body joint (80B) is enabled to be moved relative to the second part (70).

10. The rotary joint arrangement (DGA) according to claim 6,
wherein the central section (F) of the first solid body joint (80A) is enabled to be moved relative to the second part (70) in a translatory movement perpendicular to the first plane (ME1); and/or
wherein the central section (F) of the first solid body joint (80A) is enabled to be moved relative to the second part (70) by means of a rotation about an axis of rotation extending in the first direction (Z); and/or
wherein the central section (F) of the second solid body joint (80B) is enabled to be moved relative to the second part (70) in a translatory movement perpendicular to the second plane (ME2); and/or
wherein the central section (F) of the second solid body joint (80B) can be moved relative to the second part (70) by means of a rotation about an axis of rotation extending in the first direction (Z).

11. The rotary joint arrangement (DGA) according to claim 1,
wherein the first plane (ME1) and the second plane (ME2) are inclined relative to one another in such a way that the first plane (ME1) and the second plane (ME2) intersect in the common intersection line (DZ) at an angle, which is larger than or equal to 10° and smaller than or equal to 120°.

12. The rotary joint arrangement (DGA) according to claim 1,
wherein the first plane (ME1) and the second plane (ME2) are inclined relative to one another in such a way that the first plane (ME1) and the second plane (ME2) intersect in the common intersection line (DZ) at an angle, which is larger than or equal to 30° and smaller than or equal to 90°.

13. A positioning device (1), comprising the rotary joint arrangement (DGA) according to claim 1 and a linear guide device (B, FB) for guiding the first part (15) or the second part (70) of the rotary joint arrangement (DGA), wherein
the first part of the rotary joint arrangement (DGA) is guided by means of the linear guide device in such a way that the first part is enabled to be moved linearly in a second direction (X), which extends perpendicular to the first direction (Z), or
the second part (70) of the rotary joint arrangement (DGA) is guided by means of the linear guide device (B, FB) in such a way that the second part (70) is enabled to be moved linearly in a second direction (X), which extends perpendicular to the first direction (Z).

14. The positioning device (1) according to claim 13, wherein,
if the second part (70) is guided by means of the linear guide device (B, FB),
at least one linear drive (LMX1, LMX2), which is connected to the first part (15) of the rotary joint arrangement (DGA), is present for moving the first part (15) in the second direction (X).

15. The positioning device according to claim 13,
wherein the linear guide device comprises a base (B) comprising at least one flat guide surface (FF) and/or a guide beam (FB) comprising at least one flat guide surface (SF), and the second part (70) is guided by means of at least one air bearing (L1, L2, L3, L4) on the flat guide surface of the base (B) and/or on the flat guide surface (SF) of the guide beam (FB).

16. The positioning device (1) according to claim 13, wherein,
if the first part is guided by means of the linear guide device,
at least one linear drive, which is connected to the second part of the rotary joint arrangement, is present for moving the second part in the second direction (X).

17. The positioning device according to claim 13,
wherein the linear guide device comprises a base (B) comprising at least one flat guide surface (FF) and/or a guide beam (FB) comprising at least one flat guide surface (SF) and the first part is guided by means of at least one air bearing on the flat guide surface of the base (B) and/or on the flat guide surface (SF) of the guide beam (FB).
